(19) United States
(12) Patent Application Publication
(10) Pub. No.: US 2007/0198653 A1
(43) Pub. Date: Aug. 23, 2007

(54) SYSTEMS AND METHODS FOR REMOTE COMPUTER-BASED ANALYSIS OF USER-PROVIDED CHEMOGENOMIC DATA

(76) Inventors: Kurt Jarnagin, San Mateo, CA (US); Georges Natsoulis, Kensington, CA (US); Richard John Brennan, San Jose, CA (US); Brigitte Ganter Seghezzi, Mountain View, CA (US); Alexander Michael Tolley, Los Gatos, CA (US)

Correspondence Address: HOWREY LLP, C/O IP DOCKETING DEPARTMENT, 2941 FAIRVIEW PARK DRIVE, SUITE 200, FALLS CHURCH, VA, 22042-2924, US

(21) Appl. No.: 11/614,823

(22) Filed: Dec. 21, 2006

Related U.S. Application Data
(60) Provisional application No. 60/755,542, filed on Dec. 30, 2005.
(60) Provisional application No. 60/853,506, filed on Oct. 19, 2006.

(51) Int. Cl. G06F 15/16

(52) U.S. Cl. 709/217

(57) ABSTRACT

The invention provides systems and methods for remote computer-based analysis of user provided chemogenomic data. The invention includes computer-based systems and software that allow a remote user to access a centralized comprehensive chemogenomic database and use the correlative tools of that database to assess the user's data. The tools allow the user to generate a summary report of the chemogenomic/toxicogenomic analysis results obtained using the chemogenomic database.

### CROSS REFERENCE TO RELATED APPLICATIONS

This application claims priority from U.S. Provisional Application Ser. Nos. 60/755,542, filed Dec. 30, 2005, and 60/853,506, filed Oct. 19, 2006, each of which is hereby incorporated by reference in its entirety.

### FIELD OF THE INVENTION

The invention provides systems and methods for remote computer-based analysis of user provided chemogenomic and/or toxicogenomic data. In particular, the invention provides computer-based systems and software that allow a remote user to access a centralized comprehensive chemogenomic database and use the correlative tools of that database to assess the user's data and create a summary report of the chemogenomic/toxicogenomic analysis results.

### BACKGROUND OF THE INVENTION

A recently developed application for the highly-multiplexed genomic assays (e.g., gene expression microarrays) is chemogenomic and toxicogenomic analysis. The term “chemogenomics” refers to the transcriptional and/or bioassay response of one or more genes upon exposure to a particular chemical compound, for example, either a pharmacological or toxicological response (study of the latter response often is referred to as “toxicogenomics”). A comprehensive database of chemogenomic annotations for large numbers of genes in response to large numbers of chemical compounds facilitates pre-clinical analysis of a new pharmaceutical lead compound using a relatively inexpensive, short term, small-scale animal study. For example, a small number of rats may be treated with a novel lead compound, and then expression profiles are measured for different rat tissue samples using gene expression microarrays. Based on classification and correlation analysis of the transcriptional effects of the compound treatment with respect to a chemogenomic reference database, it may be possible to predict the toxicological profile and/or likely off-target effects of the new compound. This provides the drug discovery scientist with an improved understanding of a candidate molecule and the ability to select among several candidates for the compound with the fewest toxicological liabilities and the greatest pharmacological benefit. Construction of a comprehensive chemogenomic database and methods for chemogenomic analysis using microarrays are described in Published U.S. Pat. Appl. No. 2005/0060102 A1, which is hereby incorporated by reference herein in its entirety.

Notwithstanding the proven power of pre-clinical chemogenomic analysis of compounds, a major difficulty for many researchers remains the cost and time involved in building a chemogenomic database that is sufficiently comprehensive and validated to provide accurate comparisons, classifications and correlations. A typical, useful, database should include triplicate gene expression analysis data for each of at least several hundred known compounds, from several tissues each administered to rats or other animals in at least two doses (and control vehicle). Thus, the cost of building the initial database may be in the tens of millions of dollars and require years to complete. Such a cost may be prohibitive for all but the most well-funded researchers. In addition to the prohibitive construction costs, even when access to the database information is available, useful chemogenomic or toxicogenomic analyses often take months of time even for exceptionally well trained researchers, The need for lengthy analysis periods and additional training creates additional throughput problems. In view of these obstacles, there is need for systems and methods whereby a single, centralized, comprehensive database may be accessed and used by a remote user for the analysis of chemogenomic data. Specifically, there is a need for computer-based systems and methods that allow a remote user to access the database, upload chemogenomic data (in a form not accessible by unauthorized third parties), select a level of chemogenomic analysis, and receive a timely, scientifically rigorous, thorough and confidential report that provides a comprehensive, and easily understandable summary of results.

### SUMMARY OF THE INVENTION

The present inventions provide methods, software products, computer-based systems and associated distributed networks, and kits allowing users to carry out analysis of data on a remote vendor computer comprising chemogenomics database and purpose specific software that uses the client data and a vendor database to make certain calculations and prepare certain assessments.

In one embodiment, the present invention provides a method for analysis of client data using a remote chemogenomic database, said method comprising: (1) providing a remote computer connected to a distributed network comprising a client computer, wherein said remote computer comprises a chemogenomic database and analysis software; (2) transmitting executable code from said remote computer to said client computer, wherein said executable code comprises instructions for: (i) accepting input of client data and an access key; and (ii) transmitting said client data and access key to said remote computer; (3) receiving transmission of said client data and access key from said client computer; (4) analyzing said client data using said database; (5) generating a data analysis report on said remote computer; and (6) transmitting the data analysis report from said remote computer to said client computer. In one embodiment, the method is carried out wherein said method further comprises deleting the client data and the data analysis report from the remote computer after the report is transmitted to the client computer. In one embodiment, the method is carried out wherein the method further comprises deleting the executable code on the client computer after the access key and client data is transmitted to the remote computer.

In one embodiment, the method is carried out wherein the transmitted executable code further comprises instructions for validating the quality of said client data. In a preferred embodiment this validation of the client chemogenomic data comprises calculating a Pearson's correlation coefficient between the client replicate data sets. In an additional embodiment of the method, the executable code further comprises instructions for removing extraneous data from said client data.

In one embodiment, the method is carried out wherein said client data comprises experimental data, a description of said experimental data, and optionally a list of client selected compounds to be used as references. This list of reference compounds comprises those compounds selected by the client that are known or suspected to generate chemogenomic data similar to the client data.

In one embodiment, the method is carried out wherein said executable code comprises instructions for generating a graphical user interface capable of accepting client input on said client computer. In a preferred embodiment, the user interface is capable of accepting client input comprising an access key, an experimental description, and client chemogenomic data.

In one embodiment, the method is carried out wherein transmitting said client data and access key comprises transmitting a single file comprising said client data and access key. Alternatively, the client data and access key may be transmitted separately. In a preferred embodiment, the method is carried out wherein transmitting the client chemogenomic data comprises transmitting an electronic file from the client computer to the remote computer, wherein the file comprises an access key, an experimental description, and chemogenomic data.

In one embodiment, the method is carried out wherein said access key data is purchased from the vendor in combination with a corresponding chemogenomic data generation tool, (e.g., a gene expression microarray).

In another embodiment, the method further comprises providing the access key to the user via an electronic transaction, wherein the access key is necessary for the user to upload data to the remote computer for analysis.

In one embodiment, the invention provides methods and software products that carry out a quality control check of the user data before or after it is uploaded to the remote host computer. In one preferred embodiment, the quality control check method comprises uploading the user data, wherein the data comprises replicate measurements using a plurality of arrays and analyzing the correlation among the plurality of arrays used for replicate measurements; wherein a strong correlation indicates the data is of sufficient quality to upload.

In one embodiment, the method of the invention is carried out wherein the data analysis report comprises a table of pathways significantly affected as measured using a pathway impact metric. In another embodiment of the invention, the data analysis report comprises scores of the patterns of gene expression in the client compound versus classifying patterns derived from the database and a mathematical classifier selected from the group comprising neural nets, linear support vector machines, non-linear support vector machines, decision trees, mutual information analysis, and linear discriminate analysis. In another embodiment of the invention, the chemogenomic analysis report comprises the expression levels of a plurality of genes organized by metabolic pathway. In another embodiment of the invention, the chemogenomic analysis report comprises the expression levels of about 10, 15, 20 or more of the most differentially expressed genes in the user dataset.

The present invention also provides software products encoded in a computer-readable medium, wherein the software products comprise instructions for carrying out the methods of the present invention. In one embodiment, the present invention includes a software product comprising instructions for: (1) transmitting executable code from said remote computer to said client computer, wherein said executable code comprises instructions for: (i) accepting input of client data and an access key; and (ii) transmitting said client data and access key to said remote computer; (2) receiving transmission of said client data and access key from said client computer; (3) analyzing said client data using said database; (4) generating a data analysis report on said remote computer; and (5) transmitting the data analysis report from said remote computer to said client computer.

In further embodiments, the software product comprises instructions for deleting the client data and the data analysis report from the remote computer after the report is transmitted to the client computer. In another embodiment, the software product comprises instructions for deleting the executable code on the client computer after the access key and client data is transmitted to the remote computer.

In one embodiment, the software product further comprises instructions in the executable code for validating the quality of said client data. In a preferred embodiment this validation of the client chemogenomic data comprises calculating a Pearson's correlation coefficient between the client replicate data sets. In an additional embodiment of the software product, the executable code further comprises instructions for removing extraneous data from said client data.

In one embodiment, the present invention provides a kit comprising a gene expression assay device in packaged combination with an access key, wherein said access key allows analysis of data from said gene expression assay device on a remote chemogenomic database. The gene expression assay device of the kit can be a DNA microarray, a PCR reagent kit, or any other device that allows a user to obtain gene expression data. In one embodiment, the kit includes at least 3, at least 9, or at least 15 gene expression assay devices in packaged combination with one or more access keys.

### BRIEF DESCRIPTION OF THE DRAWINGS

FIG. 1 is a graphical representation of one embodiment of a system for the remote computer-based analysis of user provided data.

FIG. 2 is a graphical representation of one embodiment of the chemogenomic analysis and report.

FIG. 3 is a graphical representation of one embodiment of a graphical user interface suitable for used with the data user interface tool of this invention.

FIG. 4 depicts a panel of text and graphics from an exemplary chemogenomics analysis report showing is a histogram of the overview of compound impact.

FIG. 5 is a panel of the chemogenomics analysis report showing the gene signatures of toxicological interest.

FIG. 6 is a panel of the chemogenomics analysis report showing the most consistently up-regulated genes.

FIG. 7 is a panel of the chemogenomics analysis report showing the most significant gene changes for select biological pathways.

FIG. 8 depicts an overview of the steps in a chemogenomics study performed using the ToxFX Analysis Suite.

FIG. 9 is a flow-chart summarizing the data analysis steps in using the ToxFX Analysis Suite.

FIG. 10 depicts a screenshot of the user's computer display when using the “Study Panel” tab of the ToxFX Study Builder software.

FIG. 11 depicts a screenshot of the user's computer display when using the “Experiments” tab of the ToxFX Study Builder software.

FIG. 12 A-C depict screenshots of the user's computer display when using various functionalities of the “Compound Chooser” tab of the ToxFX Study Builder software.

FIG. 13 depicts a screenshot of the user's computer display when using the “Quality Control” tab of the ToxFX Study Builder software.

FIG. 14 depicts a screenshot of the user's computer display when using the “Report Directory” pull-down menu of the ToxFX Study Builder software.

### DETAILED DESCRIPTION OF THE INVENTION

### I. Overview

Efficient and meaningful analysis of chemogenomic data is accelerated and improved by access to large relational databases comprising gene expression findings from each of at least several hundred known compounds, from several tissues each administered in at least two doses (and control vehicle) to rats in triplicate. Such databases are expensive and time-consuming to construct. The present invention provides computer-based systems and methods that allows multiple users (e.g., clients or customers) to efficiently validate, upload, and analyze data from chemogenomic experiments using a remote chemogenomic database hosted on a centralized vendor server that is accessible via a distributed network such as the world wide web. User access to, or knowledge of, the actual data entries in the database is not necessary.

The present invention provides automated software that performs the chemogenomic analysis of the user data on the remote server and subsequently transmits a report to the user with the results. Nor is it necessary for the remote vendor server to have complete knowledge of the user data, or retain the user data after the analysis is completed. Indeed, the present invention provides computer-based systems and methods that permit anonymous, encrypted interactions between the user and the remote host database.

In many embodiments, it is preferred that no data or other information is retained on the host computer once the analysis job is completed and the chemogenomic analysis report has been transmitted to the user. The chemogenomic analysis report of the invention provides the user with results organized into sets of tables to permit rapid identification of interrelationships between behavior of different genes or gene fragments, e.g., for one or more diseases, treatments, or demographics. In one embodiment of the invention, the tables include pattern matching and pattern classification to one or more signature probability factors derived from scalar products based on sparse linear classifiers that were previously mined using the vendor database. Using the systems and methods of the present invention, a user may access the powerful information content of such signatures without knowing the actual formulation of them. Thus, the vendor may provide a client with access to powerful database tools without revealing its proprietary information.

### II. Definitions

“Chemogenomic data” as used herein, refers to any data resulting from an experiment involving treatment of an organism or tissue with a compound. Such experiments include but not limited to data such as log ratios from differential gene expression experiments carried out on polynucleotide microarrays, or data from multiple protein binding affinities measured using a protein chip. Other examples of chemogenomic data include assemblies of data from a plurality of standard toxicological or pharmacological assays (e.g., blood analytes measured using enzymatic assays, antibody based ELISA or other detection techniques). “Client data” as used herein, refers to any data or information provided by the user of the remote database. “Client data” includes actual experimental data (e.g., gene expression log ratios), descriptive information about the experimental data (e.g., experimental parameters), and other information relevant to the data (e.g., lists of related compounds that induce similar gene expression responses, etc.).

“Variable” as used herein, refers to any value that may vary. For example, variables may include relative or absolute amounts of biological molecules, such as mRNA or proteins, or other biological metabolites. Variables may also include dosing amounts of test compounds used in chemogenomic experiments.

“Signature,” “Drug Signature,” or “linear classifier” or “non-linear classifier” as used herein, refers to a function comprising a combination of variables, weighting factors, and other constants that provides a unique value or function capable of answering a classification question and whose cross-validated performance for answering a specific classification question is greater than an arbitrary threshold (e.g., a log odds ratio ≧4.0). The “classification question” may be of any type susceptible to yielding a yes or no answer (e.g., “Is the unknown a member of the class or does it belong with everything else outside the class?”). “Linear classifiers” refers to classifiers comprising a first order function of a set of variables, for example, a summation of a weighted set of gene expression log ratios. “Non-linear classifiers” refers to classifiers of the support vector Gaussian, min-max probability, regression type, or could be chosen from neural net classifiers, decision tree classifiers, mutual information classifiers, discreet Bayesian classifiers, or linear discriminate classifiers. A valid classifier is defined as a classifier capable of achieving a performance for its classification task at or above a selected threshold value. For example, a log odds ratio ≧4.00 represents a preferred threshold of the present invention. Higher or lower threshold values may be selected depending of the specific classification task. Drug Signatures include but are not limited to linear classifiers comprising sums of the product of gene expression log ratios by weighting factors and a bias term. Methods for deriving Drug Signatures from a chemogenomic database (e.g., DrugMatrix™) are disclosed in e.g., PCT publication WO 2005/07807A2, and US patent publication 2005/0060102A1, each of which is hereby incorporated by reference herein. Exemplary Drug Signatures derived from the DrugMatrix™ chemogenomic database and useful with the methods of the present invention are disclosed in U.S. Ser. No. 11/209,394, filed Aug. 22, 2005, and U.S. Ser. No. 11/326,730, filed Jan. 6, 2006, each of which is hereby incorporated by reference herein.

“Weighting factor” (or “weight”) as used herein, refers to a value used by an algorithm in combination with a variable in order to adjust the contribution of the variable.

“Impact factor” or “Impact” as used herein in the context of classifiers or signatures refers to the product of the weighting factor and the average value of the variable of interest. For example, where gene expression log ratios are the variables, the product of the gene's weighting factor and the gene's measured expression log ratio yields the gene's impact. The sum of the impacts of all of the variables (e.g., genes) in a set yields the “total impact” for that set.

“Scalar product” (or “signature score”) as used herein refers to the sum of impacts for all genes in a signature less the bias for that signature. Hence, the scalar product is a single numerical value representing the answer to a classification question addressed to a large multivariate dataset (e.g., a comprehensive chemogenomic database). A positive value of the scalar product for a sample indicates that it is positive for the classification (i.e., in the class) that is queried by the classification question.

“Array” as used herein, refers to a set of different molecules (e.g., polynucleotides, peptides, carbohydrates, etc.). An array may be immobilized in or on one or more solid substrates (e.g., glass slides, beads, or gels) or may be a collection of different molecules in solution (e.g., a set of PCR primers). An array may include a plurality of polymers of a single class (e.g., polynucleotides) or a mixture of different classes of biopolymers (e.g., an array including both proteins and nucleic acids immobilized on a single substrate). An array may include microarrays including 1000s of different DNA probes on a single glass microscope slide, or a large-scale, low-density array such as a 96-well microtiter plate. A variety of array formats (for either polynucleotides and/or polypeptides) are well-known in the art and may be used with the methods and subsets produced by the present invention. For example, photolithographic or micromirror methods may be used to spatially direct light-induced chemical modifications of spacer units or functional groups resulting in attachment at specific localized regions on the surface of the substrate. Light-directed methods of controlling reactivity and immobilizing chemical compounds on solid substrates are described in e.g., U.S. Pat. Nos. 4,562,157, 5,143,854, 5,556,961, 5,968,740, and 6,153,744, and PCT publication WO 99/42813, each of which is hereby incorporated by reference herein. Alternatively, arrays may be produces by attaching a plurality of molecules to a single substrate using precise deposition of chemical reagents. For example, methods for achieving high spatial resolution in depositing small volumes of a liquid reagent on a solid substrate are disclosed in U.S Pat. Nos. 5,474,796 and 5,807,522, both of which are hereby incorporated by reference herein.

“Array data” as used herein refers to any set of constants and/or variables that may be observed, measured or otherwise derived from an experiment using an array, including but not limited to: fluorescence (or other signaling moiety) intensity ratios, binding affinities, hybridization stringency, temperature, buffer concentrations.

“Extraneous data” as used herein refers to any data that is not essential or not critical for performing a particular data analysis function.

“Proteomic data” as used herein refers to any set of constants and/or variables that may be observed, measured or otherwise derived from an experiment involving a plurality of mRNA translation products (e.g., proteins, peptides, etc).

“Metabolomic data” as used herein refers to any set of constants and/or variables that may be observed, measured or otherwise derived from an experiment involving a plurality small molecular weight metabolites from tissues or biological fluids or exhaled gases.

“Biological signal profile” as used herein, refers to a plurality of data points, wherein each data point representative of the amount (relative or absolute) of a constituent of a biological sample (e.g., mRNA, secreted protein, metabolite).

“Sample” as used herein refers to any biological material used to derive “Chemogenomic data” or “Proteomic Data” or “Metabolomic Data” (e.g., cell culture, tissue culture, biological fluid, tissue or exhaled gas, from an organism such as an animal or human).

“Ortholog” as used herein refers to at least two genes that are related by vertical descent from a common ancestor and encode proteins with the same function in different species. Over 13000 rat-human orthologs have been annotated and curated by the Mouse Genome Informatics (MGI) group at The Jackson Laboratories). The ortholog data has been used to create high density comparative maps between rat human and mouse species (Kwitek et al. Genome Research Vol. 11, Issue 11, 1935-1943, November 2001 which is incorporated by reference herein).

A “gene expression profile” or “profile” refers to a representation of the expression level of a plurality of genes in response to a selected expression condition (for example, incubation in the presence of a standard compound or test compound). Gene expression profiles can be expressed in terms of an absolute quantity of mRNA transcribed for each gene, as a ratio of mRNA transcribed in a test sample as compared with a control sample, and the like.

The term “correlation information” as used herein refers to information related to a set of data through a relational database (e.g., a chemogenomic database as described in published US Application No. 2005/0060102A1, which is hereby incorporated by reference herein). For example, correlation information for a gene expression profile may include a list of similar profiles (profiles in which a plurality of the same genes are modulated to a similar degree, or in which related genes are modulated to a similar degree), a list of compounds that produce similar profiles, a list of the genes modulated in said profile (e.g., a drug signature), a list of the diseases and/or disorders in which a plurality of the same genes are modulated in a similar fashion, and the like. Correlation information for a compound-based inquiry can comprise a list of compounds having similar physical and chemical properties, compounds having similar shapes, compounds having similar biological activities such as similar pharmacology or toxicology, compounds that produce similar expression array profiles, and the like. Correlation information for a gene- or protein-based inquiry can comprise a list of genes or proteins having sequence similarity (at either nucleotide or amino acid level), genes or proteins having similar known functions or activities, genes or proteins subject to modulation or control by the same compounds, genes or proteins that belong to the same metabolic or signal pathway, genes or proteins belonging to similar metabolic or signal pathways, and the like. In general, correlation information is presented to assist a user in drawing parallels between diverse sets of data, enabling the user to create new hypotheses regarding gene and/or protein function, compound utility, compound pharmacology, compound toxicology, and the like.

The term “hyperlink” as used herein refers to feature of a displayed image or text that provides information additional and/or related to the information already currently displayed when activated, for example by clicking on the hyperlink. An HTML HREF is an example of a hyperlink within the scope of this invention. For example, when a user queries receives an output report from a remote vendor database according to the present invention, such as a list of the genes most induced or repressed by a selected compound, one or more of the genes listed in the output may be hyperlinked to related information. The related information can be, for example, additional information regarding the gene, a list of compounds that affect gene induction in a similar way, a list of genes having a known related function, a list of bioassays for determining activity of the gene product, product information regarding such related information, and the like.

An “applet” or “applet package” as used herein refers to executable code of relatively short length that may be quickly transmitted as a relatively small file over a network and executed on a client computer. Typically, an applet exists only transiently on the client computer and is deleted after only one or a few uses by the client.

An “access key” as used herein refers to any network transmissible information that permits the remote host to adequately identify the user and confirm that the user is entitled to gain access to the database.

### III. Methods, System and Software

A. Structural and Functional Characteristics of the Network Systems

The computer-based methods and systems of the present invention may be implemented in any distributed network environment that allows at least two-way communication between individual computers located on the network. In a preferred embodiment, the remote database is located (i.e., hosted) on a computer server connected to the internet, and the user computer(s) are also connected to the internet. In such an embodiment, communication and transmission of data between the user/client and the remote host/vendor computers may be carried out using the standard well-known internet data transfer protocols (e.g., TCP/IP). Although, the internet is a preferred distributed network environment for the present invention, other well-known network systems may also be used. For example, the methods and system may be employed in a local area network (LAN) environment, e.g., in a large corporate network system. Similarly, the methods and systems of the present invention are not limited to hard-wired connections, but may also be employed in any of the wireless network environments (e.g., WLAN, WiFi systems) well-known in the art.

B. Structure and Function of the User Interface to the Remote Database

The user interface of the present invention allows a user to: (1) select data to be analyzed; (2) pre-validate the quality of the data prior to analysis by the remote computer; (3) remove extraneous data not necessary for the analysis; (4) validate authorization to upload data and have it analyzed on the remote computer; and (5) transmit (e.g., upload) the data to the remote computer where it is automatically analyzed by resident analysis software using the chemogenomic database. Numerous other functionalities may optionally be included as part of the user interface including: receiving transmission of the chemogenomic analysis report from the remote computer; performing transactions to obtain access keys; and/or selecting further levels of analysis of the user data.

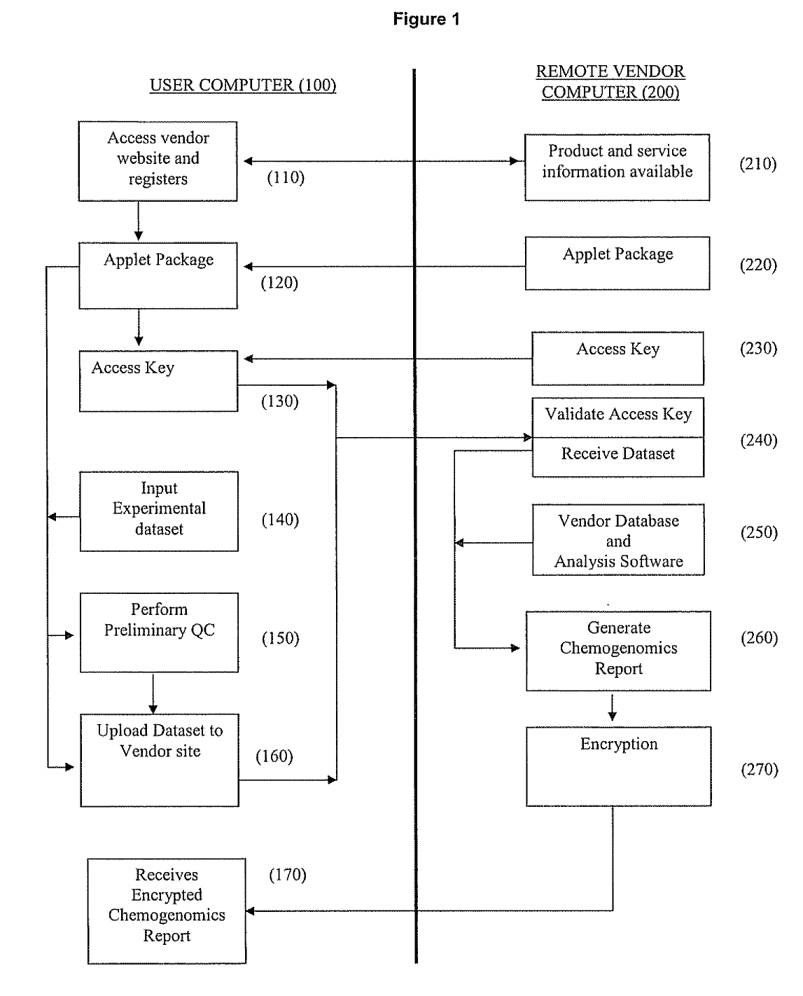

FIG. 1 is a graphical representation of the interactions between a user and the remote computer in accordance with one illustrative embodiment of the invention. Processes occurring on the user's computer (100) are depicted on the left side of the thick line and processes occurring on the vendor computer/server (200) are depicted on the right. Interactions involving data transmission across a network are depicted by arrows crossing the thick center line. A typical user interface session would include the user registering (110) through his web browser at vendor website located on the vendor server (200). This initial registration may be optional in some embodiments, and may only be required upon a first visit by the user to the web-site. Registration allows the user to access product information (210), receive executable code such as an applet package(s) (220), and optionally purchase an access key (230) (if the user does not already have one obtained through a bundled chemogenomics analysis kit purchase with a gene expression assay device).

The browser software running on the user's computer (100) may provide a run-time container for the downloaded applet (120). It also provides a storage site for the optionally purchased access key (130).

Because chemogenomic analysis of poor quality gene expression data can provide faulty, unreliable results (and waste valuable database time), a step of pre-validating the quality of the user data is highly preferred. Accordingly, the executable code (120) provides instructions for optional quality control (150) pre-validation of the user input data (140).

Once any pre-validation of quality is completed, the dataset is formatted for uploading/transmission (160) to the remote vendor server, Typically, transmission is controlled by the applet(s) (120) and the data is sent via the internet with the access key (130) to the vendor server (200). The dataset is received and the access key is validated at the vendor site (240). The chemogenomic analysis of the user data using the database (240) is performed automatically by executable code resident on the vendor server. The results of the analysis are tabulated in a chemogenomic analysis report (260) using the received user dataset (240). Preferably, user data is stored on the vendor server only so long as necessary to perform the chemogenomic analysis, and then is deleted. In alternative embodiment, user data may be stored on the server for a set period time after the analysis in order to allow a user to request an additional analysis without performing an additional upload of the data. For example, the user may be allowed to select a time period before the data is deleted form the remote server.

Typically, the chemogenomics analysis report is encrypted (270) and sent back to the user computer (170). The methods of the present invention may be implemented using any of standards, platforms, components, and other elements for an Internet access and communications with users, well known in the art of network data communications.

In one embodiment, the user interface capable of facilitating the network-based communications described in FIG. 1 is delivered to the user's computer as executable code (e.g., a computer software product such as an applet(s)) via an internet transmission from the database provider web-site, wherein the transmission is activated by clicking on a hyperlink through the user's web-browser. The user interface is automatically established on the user computer by running the executable code.

The executable code (e.g., an applet) downloaded from the vendor to the user computer comprises computer executable instructions for formatting the user dataset into a computer readable file and transmitting the file to the vendor server in a secure format (e.g., SSL) via a network connection (e.g., the internet). In preferred embodiments, the formatted user data file is encrypted using any of the well-known data encryption methods. The executable code/software product may be written in any of various suitable programming languages, such as C, C++, Fortran and Java (Sun Microsystems). The computer software product may be an independent application with data input and data display modules. The computer software products may also be component software such as Java Beans (Sun Microsystems), Enterprise Java Beans (EJB), Microsoft™ COM/DCOM, etc. In one embodiment the computer software product is an applet.

1. Access Key

An important component of the user interface is the ability to strictly control user access to the remote vendor computer. According to one embodiment of the present invention, an access key is required for the user to upload a dataset and experimental information to the vendor database and receive a chemogenomic analysis report. Any and all gene expression assay devices can be purchased in combination with an access key which is correlated to the particular type and design of the assay device.

Generally, the access key provides a code that when validated by the remote vendor computer, permits the holder of the access key (i.e., the user) to transmit experimental data to the vendor computer. Once the remote vendor computer has received the transmission of the user data (and confirmed validation of the key), automated software on the computer performs the chemogenomic analysis of the data using the resident chemogenomics database. The results of this automated computer-based analysis are then exported into a chemogenomics analysis report and returned to the customer via electronic transmission (e.g., direct download, or e-mail).

The access key may comprise any network transmissible information that permits the remote host to adequately identify the user and confirm that the user is entitled to gain access to the database. A wide range of computer-based structures and methods are well-known in the art for providing strictly controlled access to remote computers over a network and these may be used with the present invention with little or no modification.

In one embodiment of the invention, the access key provided to the user is a paper or electronic “certificate” (e.g., a software file) associated with an individual assay device of a specific type. For example, following initial login and validation of payment for use of the database, the vendor computer would automatically generate an e-mail to the user including either an alphanumeric code the user would enter through the browser, or an attached file to be copied to the user's computer that validates access. Thus, in addition to providing a code that the host server recognizes as providing authorization to use the database, the key also comprises a code (e.g., a string of alphanumerics) correlating the user's individual assay device and associated gene expression data. In a further embodiment, the access key would indicate whether the user obtained her data on a large-scale microarray (e.g., a whole genome rat array) or a relatively reduced-size array such as universal gene chip array of the type described in U.S. Ser. No. 11/114,998, filed Apr. 25, 2005, which is hereby incorporated by reference herein.

Depending on the data acquisition platform (e.g., type of microarray used), access to the database may be further limited. For example, purchasers of a “premium” chemogenomics analysis kit may be provided with a larger microarray and a specific access key that when validated provides a more comprehensive chemogenomic analysis of the uploaded data obtained on the microarray.

There may be different levels of chemogenomic analysis that may be performed (e.g., “basic” level, “premium” level) using the database. In one embodiment, the level of analysis is defined strictly on the type of access key the user submits, and cannot be altered at any point during the process by which the user interfaces with the remote computer. In another embodiment, the user may be permitted to select the level of analysis (e.g., “upgrade”) as part of the user interface process. The ability for the user to select a different level of analysis may be provided using a hyperlink-based selection prior to, or after the initial upload of the user data to the remote computer. User activation of the “analysis selection” hyperlink would activate an additional user interface that would permit user entry of information necessary to validate an “upgraded” analysis (e.g., accept payment information).

The access key may be purchased by the user through any of many well known sales mechanisms. For example, the access key may be purchased as part of a chemogenomic analysis kit. In one embodiment, such a kit provides a hard-copy of the access key (e.g., printed, or otherwise encoded on a card), together with a gene expression assay devices such as a microarray and literature describing the process for obtaining an analysis report. For example, the chemogenomics analysis kit may include an access key in the form of a certificate bundled with any of the well-known commercial microarrays Affymetrix GeneChip® (e.g., ToxFX 1.0 Array, GeneChip® Rat Genome 230 2.0 Array, Human Genome Focus Array, Human Cancer G110 Array, Human Genome U133 Plus 2.0 Array, Rat Genome U34 Set, Arabidopsis Genome Array) or the Agilent™ microarray suite (e.g., Whole Human Genome Oligo Microarray, Rat Oligo Microarray, Whole Mouse Genome Oligo Microarray). This kit may optionally include nucleotide labeling reagents, hybridization reagents, and literature describing the process for obtaining a chemogenomics analysis report packaged with the array and access key. Other kits envisioned by the present invention, would be based on other assay methods, reagents and/or devices for measuring gene expression, such as RT-PCR.

Alternatively, the access key may be purchased separately from the assay reagents and/or device. For example, the access key may be purchase at the web-site of a database provider. Typically, in such an embodiment the database provider web-site would provide a selection of different access keys for purchase depending on the type of gene expression assay device used. Alternatively, the access key may be purchased from the web-site of the manufacture of the gene-expression assay reagents and/or device. For example, if a user purchases a custom-array from an array provider, that provider may also allow purchase of an access key specific for that custom array.

### 2. User Data Quality Control (QC) and Transmission

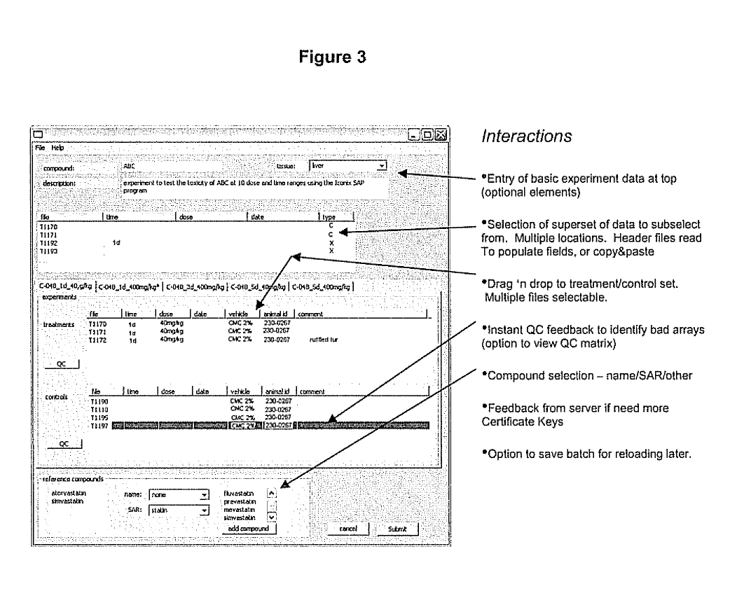

The user inputs the experimental dataset and the experimental study description. A screenshot from an illustrative user dataset input page in embodiment of user interface software of the present invention is shown in FIG. 3. The dataset can be input in any computer readable form. In one embodiment the dataset is input as an Excel or other spreadsheet readable file format. In one embodiment, the user dataset is input as a “CHP” file generated by the Array Assist™ Light or Affymetrix GCOS software. Generation of the CHP formatted files from Affymetrix GeneChip® expression data is described in e.g., “Affymetrix Data Analysis Fundamentals” guide (Affymetrix Part No. 701190) or “Affymetrix GeneChip® Operating Software Users Guide” (Affymetrix Part No. 701439), both available from Affymetrix, Inc., Santa Clara, Calif. In one embodiment, the user dataset is input using a browser to select files on the user's local computer, wherein the selected files are copied to software programs in the applet package.

In one embodiment the user performs an optional preliminary quality check (i.e., quality control, or “QC” step) on the input dataset using the computer software product of this invention. This step focuses only on the reproducibility of the biological replicates and is in addition to quality control steps taken for the preparation of samples and array hybridization procedures. In one embodiment, the quality control step is required before any data can be submitted for analysis to the remote vendor database. In an alternative embodiment, an automated quality check is performed using the computer software product of this invention after the dataset is sent to the vendor computer. In yet another embodiment of this invention, the quality control check is performed at both the user site on the user computer and repeated at the vendor site. The computer software product comprises computer code capable of performing a preliminary quality control check of the input dataset comprising data replicates.

In one embodiment, the preliminary quality control check comprises calculating a Pearson correlation coefficient on the replicate dataset and determining if the replicate set's correlation coefficient exceeds some critical threshold established by the vendor. For example, user data file (e.g., CHP file) whose correlation to other experimental replicates falls below a threshold (e.g., r2=0.80) is considered to be an outlier and removed. Other methods of quality control of replicate gene expression data are well-known in the art.

Once the dataset has been input and a quality control check has been optionally performed, the client then enters the access key code. The access key code (e.g., printed on a certificate purchased with an array) comprises an identifying data string (e.g., alphanumerics) which entitles the user to send the dataset to the vendor server via the internet and receive a report.

C. Chemogenomic Analysis of User Data and Generation of Analysis Report

An automated report is generated on the vendor server that is optionally encrypted. The report is transmitted to the client via the internet. The dataset is optionally deleted from the vendor data set after the report has been generated and sent to the user.

The methods of analysis are encoded in analysis software that is stored in executable form on the remote computer. A range of chemogenomic analysis methods and/or algorithms for use with a comprehensive chemogenomic database are well-known in the art. For example any of analysis methods may be used as described in published US Patent Applications 2005/0060102A1, 2003/0180808A1, 2006/0035250A1, and published PCT application WO2005/17807A2, each of which is hereby incorporated by reference.

The methods and systems of the present invention ultimately provide a chemogenomics analysis report to the user, wherein the report comprises a series of tables representing various aspects of the chemogenomic analysis. Generally, the chemogenomic analysis report comprises an electronic file capable displaying (or producing a printed hard copy of) a plurality of tables corresponding to different specific chemogenomic analyses performed on the remote computer using the database. The report comprises at least one electronic file. Any of the well-known file formats useful for displaying text and graphics may be used for the report of the present invention. For example a postscript data formatted file, e.g., a “PDF” format readable with Adobe Acrobat Reader. In one embodiment, the electronic file is provided in a “fixed” read-only format that does not permit further changes to the data. In alternative embodiments, reports may be provided in formats that permit user manipulation of the data in the report. However, it is preferred that the report file format allows the user to export graphics from the report into other file formats (e.g., PowerPoint ™) via cut-and-paste manipulations well-known in the software arts.

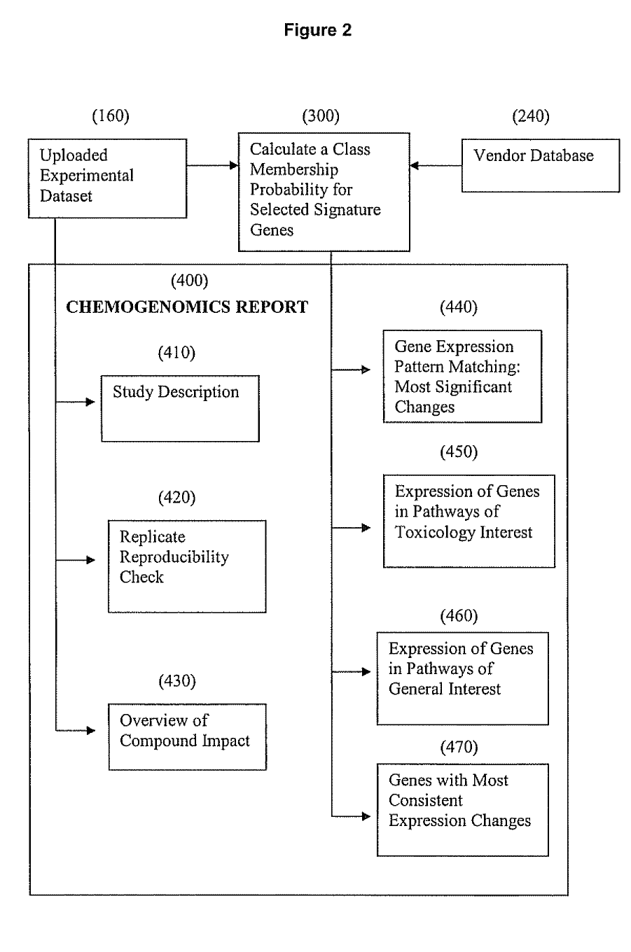

FIG. 2 provides a graphical representation of the generation and composition of an exemplary chemogenomics report (400). The uploaded experimental dataset (160) is processed to generate an output file display of the following: Study Description (410); an optional Replicate Reproducibility Check (420); and an Overview of the Compound Impact (430). The uploaded experimental dataset (160) is also processed with data from the vendor database (240) to generate a class membership probability for select signature genes (300). The class membership probability can be calculated for any signature group of interest in order to generate a series of tables. Other tables that provide value to the customer include gene groups of interest to various scientific user types, these tables include: Most Significant Gene Expression Pattern Matching (440); Expression of Genes of Toxicology Interest (450); Expression of Genes in Pathways of General Interest (460) and Genes with the most consistent expression changes (470).

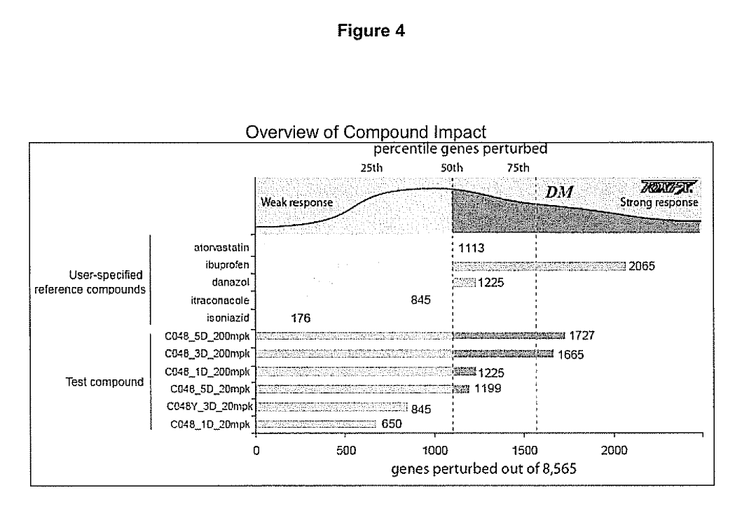

In one embodiment of the invention, the chemogenomic analysis report comprises a histogram representing the overview of compound impact. For example, FIG. 4 shows an illustrative panel including text and graphical depiction of user specified reference compound and the test treatment (e.g., compound or experimental conditions) in relation to the distribution of weak and strong responding compounds. FIG. 4 also shows the number of genes perturbed by the user-supplied query compounds relative to the 4500 compound-dose-time treatments in the exemplary Iconix DrugMatrix® database. A total of 630 compounds are represented in DrugMatrix. A gene perturbation is defined as a log₁₀ ratio for a given gene having p-value of <0.05.

The classification method used within DrugMatrix™ for the generation of a classifier (i.e., Drug Signature®) is based on a linear classification algorithm termed SPLP (SParse Linear Programming) (see e.g., published PCT application WO2005/17807A2, which is hereby incorporated by reference herein in its entirety). This classifier is able to rapidly interpret the data from up to 30,000 genes because it looks for specific patterns or signatures in the data. A modified algorithm based on SPLP, “A-SPLP,” also has been used to generate high performing linear classifiers. A-SPLP is described in co-pending U.S. patent application Ser. No. 11/332,718, filed Jan. 12, 2006, which is hereby incorporated by reference herein in its entirety.

A Drug Signature classifier consists of a list of weighted genes that can contribute to the understanding of the biology associated with the classification phenotype (see e.g., published US Patent Applications 2005/0060102A1 and 2006/0035250A1, each of which is hereby incorporated by reference herein in its entirety). The classification phenotypes for which the Drug Signatures are derived are traditional parameters such as histopathology, clinical chemistry, and organ and body weights. These traditional toxicology measurements are collected from compound treated rats in parallel to expression profiling at the time that the DrugMatrix™ reference database is generated (see e.g., published US Patent Application 2005/00601 02A1). These measurements identify drugs and treatment conditions which cause specific kinds of toxicity and, thus, serve to identify treatments that are positive for a particular phenotype. This is considered to be the positive class. Other treatments that do not exhibit any indication of this particular phenotype, and are therefore considered negative treatments, are assigned to the negative class. Together, the gene expression patterns in the positive and negative classes constitute the training set. The classification algorithm identifies gene expression changes that are strongly associated with the phenotype of interest; that is, distinguishes the positive sample set from the negative sample set. These genes with their associated expression levels constitute a Drug Signature®. Once identified, the Drug Signatures can then be applied to predict, from the expression pattern, the likelihood that a traditional toxicological endpoint would occur in rats dosed with a new compound not contained in the training set. Since many of these gene expression patterns are evident earlier than the endpoint phenotype, the likelihood for a particular toxic response can be predicted earlier than when using more traditional toxicology assays.

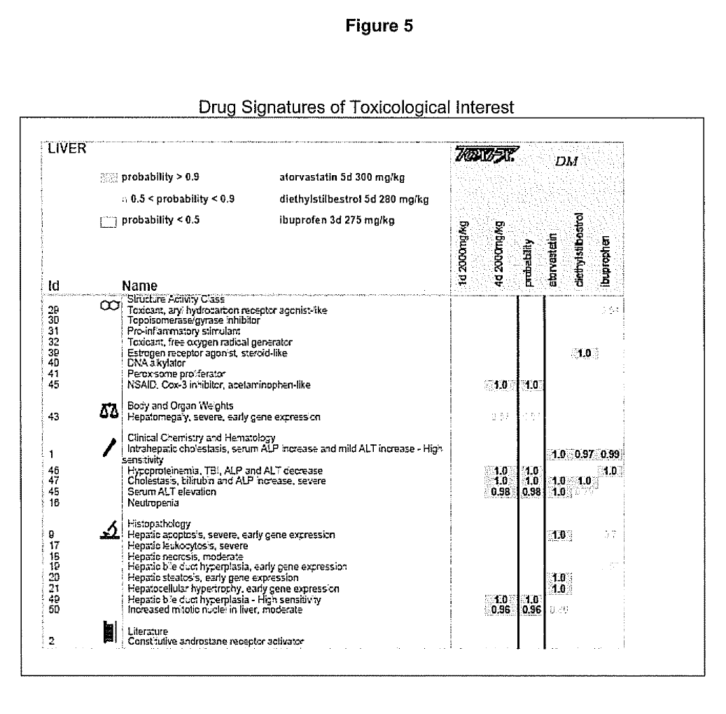

In one embodiment, the Iconix Drug Signature® approach compares the gene expression pattern(s) induced by the test compound treatment(s) to a library of pre-calculated expression patterns. In one embodiment of the invention the chemogenomic report comprises a table of Drug Signatures of toxicological interest (FIG. 5). In yet another embodiment of the invention, the chemogenomics report comprises a table of Drug Signatures of general interest. FIG. 5 shows the degree of match to a given Drug Signature, displayed as a numerical value, called the class membership probability. This number indicates the likelihood that the particular biological, pharmacological, or toxicological property indicated by the Drug Signature exists in the test treatment. The scale facilitates rapid and visual compound classification. Drug Signatures facilitate the diagnosis and mechanistic understanding of a wide variety of chemical effects on biological systems. The class membership probability value reported in the table reflects the degree to which the gene expression pattern caused by the treatment in question matches the gene expression pattern defined by the Drug Signature. If the class membership probability value is very near 1, then there is high confidence that the experiment has the property indicated by the Signature. If the probability is near 0 there is high confidence that the treatment does not have the property. Values near 0.5 indicate that evidence that the treatment does or does not have the property is equivocal.

In one embodiment of the invention, the chemogenomic report comprises a table of probability matches for 70 or 80 or more Drug Signatures of toxicological interest. Class membership probability scores for the test compound treatments against Drug Signatures designated by the vendor as being of key toxicological interest are shown in the table.

Drug Signatures are precise and predictive biomarkers of biologically meaningful endpoints. The degree of match to a given Drug Signature is displayed as a numerical value, called the class membership probability. The class membership probability is derived from the scalar product of a drug signature and indicates the likelihood that the gene expression pattern is associated with a particular biological, pharmacological, or toxicological property. The scale facilitates rapid and visual compound classification. Drug Signatures facilitate the diagnosis and mechanistic understanding of a wide variety of chemical effects on biological systems.

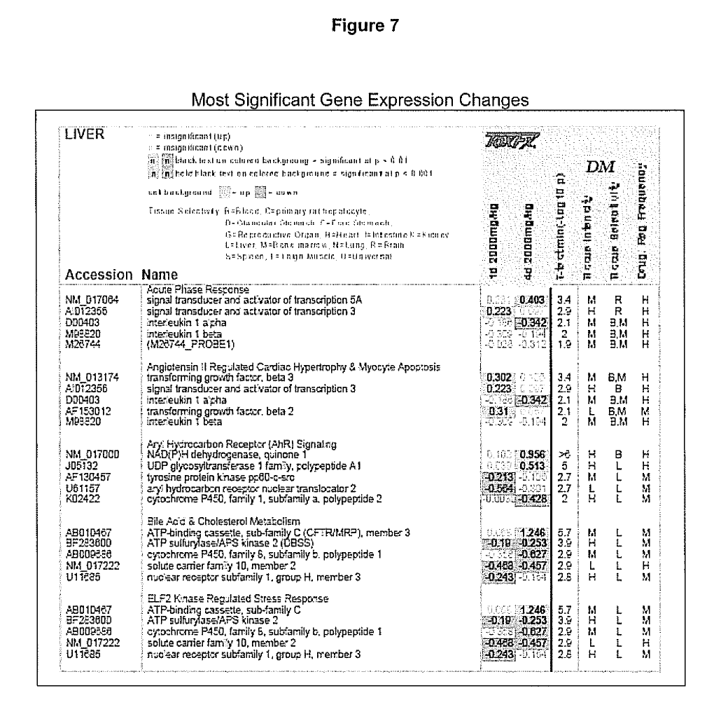

In one embodiment of the invention, the chemogenomic report comprises a table of the 3, 5, 10, or more of the most significantly changed genes within a plurality of biological pathways of interest (FIG. 7). The table can display the accession number (optionally hyperlinked to NCBI GenBank or other data sources of both public and private nature) and a short description of the gene. The table lists the log₁₀ ratios for the treatments of interest and columns of data to aid in the interpretation and analysis of the experiment. In one embodiment of the invention the columns of data can include the following:

1) Significance: Significance as used herein (column labeled T-test min p in FIG. 7) which is defined as the minimum p-value of the log₁₀ ratio of a given gene across all query treatments. Each of the 5 gene pathway tables is sorted by significance. The value can be reported as the minus log₁₀ (p-value) or the p-value itself.

2) Tissue Intensity and Selectivity: These annotations are derived from a plurality control tissue treatment sets, each set containing a plurality untreated control hybridizations.

The plurality of different tissues included are comprised of blood (B), bone marrow (M), brain (R), fore-stomach (F), heart (H), intestine (I), kidney (K), liver (L), lung (U), reproductive organ (G), spleen (S) and thigh muscle (T).

3) Tissue Intensity: The Tissue Intensity is derived from the ranking of probe intensity within each tissue. For each tissue, log₁₀ normalized signal intensity values for each probe is listed. In one embodiment probes are grouped by quartile with High (H) being the top quartile of intensity values, Medium (M) being the middle two quartiles of intensity values, and Low (L) being the bottom quartile of intensity values.

4) Tissue Selectivity: Tissue Selectivity is based on the tissue selectivity index (TSI), which is the average log₁₀ normalized signal intensity in tissue X divided by the next highest average log₁₀ normalized signal intensity. In one embodiment of the invention, the tissue selectivity indices are sorted in ascending order. A probe is considered selective for tissue X if within the top quartile of the ranked TSI for tissue X. If, based on this criterion, a probe does not get annotated with a tissue label, the annotation will be U for ubiquitous. If a probe was annotated with a Tissue Intensity of Low (L), the probe will not be annotated with any specific tissue but rather with U for ubiquitous; this is to prevent spurious annotation of very low level expressed probes with high TSI indexes due to a lack of signal in certain tissue hybridizations. Only the top three tissues are listed in the Tissue Selectivity column.

5) Drug Regulation Frequency: The Drug Regulation Frequency (DRF) calculation provides a higlier-level understanding of a gene's frequency of regulation by all vendor database treatments profiled in a given tissue. DRF represents the percent of experiments that either up- or down-regulate a gene by a statistically significant amount within a given tissue. The DRE indicates whether the gene in question is commonly perturbed by compound treatments or is generally not transcriptionally-regulated in response to chemical exposure. DRF identifies genes that might be uniquely or unusually regulated by an experimental treatment and allows one to compare and contrast these “unusual genes” with genes that do frequently change in response to chemical exposure and might therefore form part of a xenobiotic-response network. DRF is calculated by counting all dose-time-tissue combinations where the average log₁₀ normalized signal in the treated group is significantly different (e.g., p <0.05) from the average log₁₀-normalized signal of the vehicle controls. The Drug Regulation Frequency is then the percentage of all dose-time-tissue treatments where the probe is perturbed. DRF is calculated independently across a plurality of tissues, comprising: bone marrow, brain, heart, intestine, kidney, liver, spleen, primary rat hepatocytes, and thigh muscle.

6) DRF Interpretation: A high drug regulation frequency (DRF) indicates that the gene in question is commonly perturbed by compound treatments. Perturbation of a gene with a high DRF is generally not considered significant unless the magnitude of the response is extreme or this gene is co-regulated with other genes in a pathway (i.e., a single gene regulation is not as significant as the regulation of several pathway genes). A low DRF indicates that the gene might be uniquely or unusually perturbed by an experimental treatment. These “rarely regulated genes” may therefore be useful biomarkers of compound exposure. In one embodiment, the Drug Regulation Frequency ranking is binned into three categories: H (high), M (medium) and L (low). In one embodiment of the invention, if the percent perturbation falls within the highest 10 percentile compared to all the probes on the array, it is annotated as H (high); if it falls within the lowest 10 percentile, it is annotated as L (low). Probes in the range between the highest and lowest 10 percentiles are annotated as having M (medium) Drug Regulation Frequency.

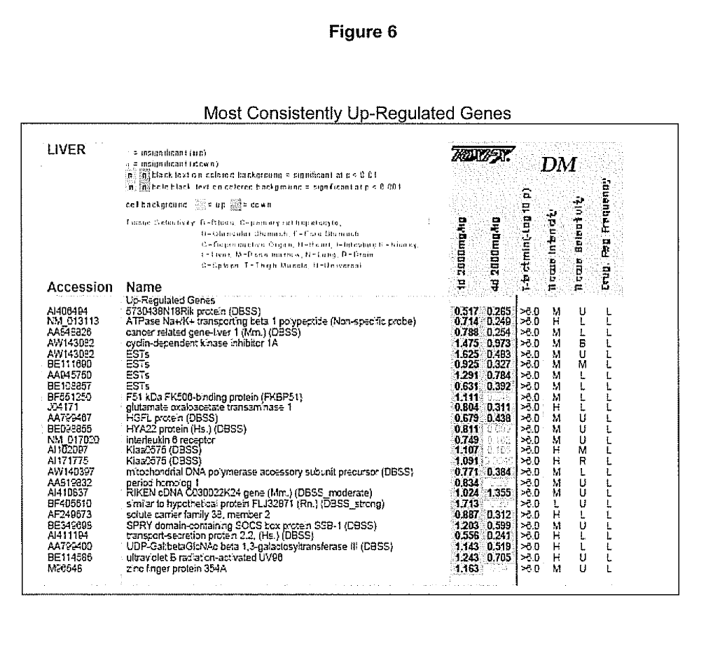

In one embodiment of the invention, the chemogenomics report comprises a table of the most consistent gene changes in a dataset. FIG. 6 shows an example of one embodiment of the invention, wherein the 25 most consistently up-regulated genes across all query experiments are shown.

In one embodiment of the invention, consistency of regulation is calculated by the average log₁₀ ratio for a given gene across all of the submitted treatments divided by the standard deviation of the log₁₀ ratios for that gene across all of the submitted treatments. Up-regulated genes are ranked by their consistency score across all query experiments and the top genes from the list shown. The most down-regulated genes are defined similarly, except that the list of genes is sorted by the minimum consistency score. In one embodiment of the invention, genes are shown as probe accession number (optionally hyperlinked to GenBank) and a descriptive name. If the gene is part of an annotated pathway, the pathway ID number is optionally provided. In one embodiment of the invention, genes are further annotated with Tissue Specificity, Tissue Intensity and Drug Regulation Frequency of any descriptor as known in the art. In an alternative embodiment of the invention, all calculated and tabulation results of the uploaded dataset can be sent to the user in the form of a tab delimited text file (e.g., Excel™).

In another embodiment, the report includes a replicate reproducibility check (RRC). The RRC represents Pearson's correlation coefficients between all the arrays in the study. It has been found that inclusion of a poorly correlating array in a replicate set may lead to erroneous chemogenomics analysis conclusions. Typically, a Pearson's correlation of less than about 0.8 indicates a technical problem with the array. Examples of technical problems include: poorly processed (RNA isolation or CRNA preparation); mislabeled samples or file labeling; and array hybridization or scanning problems

D. Databases Useful with the Present Invention

The present invention is useful for analysis of chemogenomic data in combination with a remote large database. The database can include any of the well known genomic data types (e.g., sequence, physical, genetic, bibliographic, genetic, organism, molecular, pharmacological, and toxicological data). Examples of molecular databases useful according to the method of this invention include e.g., GenBank, Swiss-Prot, European Molecular Biology Laboratory Nucleotide Sequence (EMBL). Examples of genetic databases useful according to the method of this invention include Genome Database (GDP), Online Mendelian Inheritance in Man (OMIN). The method of this invention can also be used with an organism database e.g., E. coli, mouse, rat, or plant. Gene expression databases are particularly useful for the methods of this invention. Examples of gene expression databases include e.g., dbEST, Gene Cards, Globin Gene Server, Merck Gene Index.

An example of a chemogenomic database useful for this invention is the DrugMatrix™ database. DrugMatrix™ is a drug treatment database comprised of over 600 different reference compounds and more than 95 toxicants. These treatments are profiled in up to 8 different tissues of rats. Over 3700 dose-time-tissue combination are included in the database. A variety of data types including microarray data, clinical chemistry and hematology data, histopathology reports and 130 in vitro pharmacological assays are included in the database. Construction of this comprehensive chemogenomic database and methods for chemogenomic analysis using microarrays are described in Published U.S. Pat. Appl. No. 2005/0060102 A1, which is hereby incorporated herein by reference in its entirety. A more detailed description of the construction of DrugMatrix™ is provided in Example 1.

E. Gene Expression Assay Devices Useful with the Present Invention

The databases can be populated by gene expression data measured by any method known in the art (e.g., expressed sequence tags, nucleic acid microarrays, subtract cloning, differential display, serial analysis of gene expression (SAGE)). Any assay format to detecting gene expression may be used to populate the database and as input data for analysis. For example, traditional Northern blotting, dot or slot blot, nuclease protection, primer directed amplification, RT-PCR, semi- or quantitative PCR, branched-chain DNA and differential display methods may be used for detecting gene expression levels. Methods of the invention may be most efficiently designed with hybridization-based methods for detecting the expression of a large number of genes. Hybridization assays may include solution-based and solid support-based assay formats. Solid supports containing oligonucleotide probes for measuring differential expression can be filters, polyvinyl chloride dishes, particles, beads, microparticles or silicon or glass based chips, etc. Such chips, wafers and hybridization methods are widely available, for example, those disclosed by Beattie (WO 95/11755). In one embodiment, microarrays useful for the method of this invention include microarrays in the GeneChip® family of devices manufactured by Affymetrix, Inc. (Santa Clara, Calif.).

Any solid surface to which oligonucleotides can be bound, either directly or indirectly, either covalently or non-covalently, can be used. A preferred solid support is a high density array or DNA chip. These contain a particular oligonucleotide probe in a predetermined location on the array. Each predetermined location may contain more than one molecule of the probe, but each molecule within the predetermined location has an identical sequence. Such predetermined locations are termed features. There may be, for example, from 2, 10, 100, 1000 to 10,000, 100,000 or 400,000 or more of such features on a single solid support. The solid support or the area within which the probes are attached may be on the order of about a 1-10 square centimeter(s).

The present invention is useful with an array comprising a reagent set made up of a set of nucleic acids which are non-redundant classifiers corresponding to a plurality of genes from a chemogenomic dataset, wherein the chemogenomic dataset comprises expression levels for a plurality of gene measured in response to a plurality of compound treatments known as a universal gene chip array. The universal array and other devices comprising reduced subsets of reagents representing highly informative genes useful with the present invention have been described in U.S. Ser. No. 11/114,998, filed Apr. 25, 2005, and published US patent application 2006/0035250A1, each of which is hereby incorporated by reference herein for all purposes.

The systems and methods of the invention as described above are exemplified below. These Examples are offered as illustrations of specific embodiments and are not intended to limit the inventions disclosed throughout the whole of the specification.

### EXAMPLES

### Example 1

### Construction of Chemogenomic Reference Database (DrugMatrix™)

This example illustrates the construction of a large multivariate chemogenomic dataset based on DNA microarray analysis of rat tissues from over 580 different in vivo compound treatments. This dataset was used to generate toxicological and pharmacological endpoint signatures comprising genes and weights. Numerous Drug Signatures (i.e., linear classifiers) have been derived from the DrugMatrix™ database, and employed for chemogenomic analysis in the instant invention.

The detailed description of the construction of this chemogenomic dataset is described in Examples 1 and 2 of Published U.S. Pat. Appl. No. 2005/0060102 A1, published Mar. 17, 2005, which is hereby incorporated by reference for all purposes. Briefly, in vivo short-term repeat dose rat studies were conducted on over 580 test compounds, including marketed and withdrawn drugs, environmental and industrial toxicants, and standard biochemical reagents. Rats (three per group) were dosed daily at either a low or high dose. The low dose was an efficacious dose estimated from the literature and the high dose was an empirically-determined maximum tolerated dose, defined as the dose that causes a 50% decrease in body weight gain relative to controls during the course of the 5 day range finding study. Animals were necropsied on days 0.25, 1, 3, and 5 or 7. Up to 13 tissues (e.g., liver, kidney, heart, bone marrow, blood, spleen, brain, intestine, glandular and nonglandular stomach, lung, muscle, and gonads) were collected for histopathological evaluation and microarray expression profiling on the Amersham CodeLink™ RUI platform. In addition, a clinical pathology panel consisting of 37 clinical chemistry and hematology parameters was generated from blood samples collected on days 3 and 5.

In order to assure that all of the dataset is of high quality a number of quality metrics and tests are employed. Failure on any test results in rejection of the array and exclusion from the data set. The first tests measure global array parameters: (1) average normalized signal to background, (2) median signal to threshold, (3) fraction of elements with below background signals, and (4) number of empty spots. The second battery of tests examines the array visually for unevenness and agreement of the signals to a tissue specific reference standard formed from a number of historical untreated animal control arrays (correlation coefficient >0.8). Arrays that pass all of these checks are further assessed using principle component analysis versus a dataset containing seven different tissue types; arrays not closely clustering with their appropriate tissue cloud are discarded.

Data collected from the scanner is processed by the Dewarping/Detrending™ normalization technique, which uses a non-linear centralization normalization procedure (see, Zien, A., T. Aigner, R. Zimmer, and T. Lengauer, 2001. Centralization: A new method for the normalization of gene expression data. Bioinformatics) adapted specifically for the CodeLink microarray platform. The procedure utilizes detrending and dewarping algorithms to adjust for non-biological trends and non-linear patterns in signal response, leading to significant improvements in array data quality.

Log ratios are computed for each gene as the difference of the averaged logs of the experimental signals from (usually) three drug-treated animals and the averaged logs of the control signals from (usually) 20 mock vehicle-treated animals. To assign a significance level to each gene expression change, the standard error for the measured change between the experiments and controls is computed. An empirical Bayesian estimate of standard deviation for each measurement is used in calculating the standard error, which is a weighted average of the measurement standard deviation for each experimental condition and a global estimate of measurement standard deviation for each gene determined over thousands of arrays (Carlin, B. P. and T. A. Louis. 2000. “Bayes and empirical Bayes methods for data analysis, ” Chapman & Hall/CRC, Boca Raton; Gelman, A., 1995. “Bayesian data analysis,” Chapman & Hall/CRC, Boca Raton). The standard error is used in a t-test to compute a p-value for the significance of each gene expression change. The coefficient of variation (CV) is defined as the ratio of the standard error to the average log ratio, as defined above.

### Example 2

### Analysis of Preclinical Compound Treatment Data Using a Vendor Chemogenomic Database on a Distributed Network

This example illustrates the use of the present invention to carry out chemogenomics analysis of a user's experimental data on a remote database and generation of chemogenomic analysis report.

A. User Experimental Data

A user/client performs an in vivo treatment study in rats of a compound designated C-048. A summary of the experimental parameters are shown in Table 1. The compound at 2 doses (MTD and FED) and the test vehicle (5% CMC) was administered to rats in triplicate. Liver tissue was harvested, RNA samples were generated and labeled, and Affymetrix Rat Genome Microarrays were hybridized with the labeled RNA samples according to the methods described Examples 1 and 2 of Published U.S. Pat. Appl. No. 2005/0060102 A1, published Mar. 17, 2005, which is hereby incorporated by reference for all purposes.

TABLE 1
Summary of user array-based rat compound treatment study

| | |
|---|---|
| Study designation | Liver 23456-04 |
| Test compound | C-048 (lot 23456-04) |
| Dosing schedule | QD |
| Length of Administration | 1, 3, 5 |
| (days) | |
| Vehicle | 5% CMC |
| Route | Oral gavage |
| Strain | Sprague-Dawley CD (SD) IGS BR |
| Age | 6-8 Weeks |
| Weight (±Standard | 190 ± 20 g |
| deviation) | |
| Target Preparation Protocol | ABC-002345, “Tissue Harvest for RNA |
| | collection” |
| Array Platform | RG230-SAP |

B. User Interface with Remote Database

In order to obtain a chemogenomics analysis of the user data obtained as described above, the user/client logs onto the remote vendor website, registers and receives a transmission from the remote computer including executable code in the form of an applet package(s). The client additionally may purchase access keys through the vendor website which correspond to the array type used to generate the experimental data.

The applet is executed (automatically or manually) on the client computer. The user/client then inputs an experimental summary and data into a GUI generated by the applet package (see e.g., illustrative user interface software screenshot shown in FIG. 3). Data entry is by user selection of data files (e.g., CHP format files) resident on the user/client's computer.

Typically, the user/client also chooses a series of three or more reference compounds from the available list in displayed by the GUI. These reference compounds possess well understood mechanisms of action and or toxicology as known to the client. In this example, the selected reference compounds, isoniazid, itraconazole, danazol and 1-napthyl-isothiocyanate are long time point, high dose reference treatments chosen to provide perspective by which to interpret the findings.

The client data is then pre-validated for quality (e.g., reproducibility between arrays). Pre-validation of quality is carried out by quality control program encoded in the executable instructions of the applet package. Client data from microarray experiments that fail the preliminary quality control screen are automatically excluded from the experimental data that is uploaded to the vendor server.

Prior to submission of the data validity of the access key(s) are verified and the users account is queried to verify the presence of sufficient key(s) to perform the analysis.

The client then submits the experimental summary and data in addition to the appropriate number of access keys to the vendor server using the applet software. The applet compresses the data using any of a number of data compression programs (e.g., WinZip® or Stuffit®) for transmission. Additionally, the applet may exclude extraneous data and failed data replicates. Extraneous data comprises control elements used by the manufacture to quality control the array but which are not used by the programs described herein for quality controls. The access key and compressed experimental data are transmitted to the vendor server for validation and analysis.

C. Chemogenomic Analysis and Report

The chemogenomic analysis of the client data is performed by the remote computer using the resident chemogenomic database and analysis software. A detailed chemogenomic analysis report is generated.

FIG. 2 is a simplified graphical representation of the generation and composition of an exemplary chemogenomics report (400). The uploaded experimental dataset (160) is processed to generate an output file display panels of the following: Study Description (410); an optional Replicate Reproducibility Check (420); and an Overview of the Compound Impact (430). The study description panel includes all identifying information related to the experimental conditions as well as the user chosen reference compounds. A replicate reproducibility check is executed on experimental data that comprises replicate data. The replicate reproducibility check is similar to the reproducibility check performed on the client computer. A table summarizing the findings is generated.

An overview of the experimental compound impact on the gene expression is provided as a histogram showing number of genes whose expression levels are perturbed by the treatment (FIG. 4). This is a broad indication of the impact of the compound on the tissue at the dose tested. The numbers of gene expression perturbations induced by the reference and test compounds in DrugMatrix™ database are also indicated as is the distribution histogram of gene changes caused by hundreds of drugs tested in DrugMatrix™.

Further chemogenomics analysis is based the calculation of class membership probability values of select genes in experimental data in relation to data from the DrugMatrix™ database. The class membership probability is the value of a quantitative match of the query compounds gene expression profile to a given Drug Signature. This value indicates the likelihood that the particular biological, pharmacologic, or toxicological property indicated by the Drug Signature is present or is not present in the test treatment. This scale facilitates rapid and visual demonstration of compound classification. Drug Signatures reduces the complexity of thousands of gene expression changes down to a collection of precise and predictive biomarkers for biologically meaningful endpoints, facilitating the diagnosis and understanding of biological mechanism of compound effects. The class membership probability value are reported in tables which reflects the degree to which the gene expression pattern caused by the treatment in question matches the gene expression pattern defined by the Drug Signature.

If the class membership probability value is very near 1, then there is high confidence that the experiment has the property indicated by the Signature. If the probability is near 0 there is high confidence that the treatment does not have the property. Values near 0.5 indicate that evidence that the treatment does or does not have the property is equivocal.

In one table of the chemogenomics analysis report, the Drug Signatures of Toxicological Interest, the client experimental data are compared to the expression patterns of rats treated with reference compounds, ibuprofen, atovastatin, and diethylstibestol. Probability matches to 49 Drug Signatures of toxicological interest are calculated. Class membership probability scores for the test compound treatments against 49 Drug Signatures that are of key toxicological are included in the table. A portion of the table is shown in FIG. 5. The table shows the overall performance of the test compound treatments on Drug signatures, with all of the significant probability scores listed. Scores between 0.0 and 0.5 are not shown. Drug Signatures are identified by their signature ID number and given a descriptive name. A companion table in the chemogenomic analysis report includes a table of expression pattern match of Drug Signatures of general interest.

The most significant gene changes are also derived and analyzed by the methods of this invention. The a table showing the analysis results of five most significantly changed genes within 19 different biological pathways of key toxicological interest is included in chemogenomics report. A panel showing a subset of that table is shown in FIG. 5. The first two columns show accession number and a short description. The next set of columns (labeled LogR) lists the log₁₀ ratios for the treatments of interest.

A pictorial representation of each pathway, outlining the position and role of each gene in its context within the particular biological process can also be displayed (FIG. 6). For the purpose of this analysis, significance (column labeled T-test min p) is defined as the minimum p-value of the log₁₀ ratio of a given gene across all query treatments. Each of the 5 gene pathway tables is sorted by significance. Reported here is the minus log₁₀ (p-value) rather than the p-value itself. Additional contextual information is provided in the last three columns of the table, including ‘Tissue Intensity and Selectivity’. These annotations are derived from 12 control tissue treatment sets, each set containing three untreated control hybridizations. The 12 different tissues included in this analysis are blood (B), bone marrow (M), brain (R), forestomach (F), heart (H), intestine (I), kidney (K), liver (L), lung (U), reproductive organ (G), spleen (S) and thigh muscle (T). The Tissue Intensity is derived from the ranking of probe intensity within each tissue. For each tissue, log₁₀ normalized signal intensity values for each probe is sorted in ascending order. Probes are grouped by quartile with High (H) being the top quartile of intensity values, Medium (M) being the middle two quartiles of intensity values, and Low (L) being the bottom quartile of intensity values. Tissue Selectivity is based on the tissue selectivity index (TSI), which is the average log₁₀ normalized signal intensity in tissue X divided by the next highest average log₁₀ normalized signal intensity. For each tissue, the tissue selectivity indices are sorted in ascending order. A probe is considered selective for tissue X if within the top quartile of the ranked TSI for tissue X. If, based on this criterion, a probe does not get annotated with a tissue label, the annotation will be U for ubiquitous. If a probe was annotated with a Tissue Intensity of Low (L), the probe will not be annotated with any specific tissue but rather with U for ubiquitous; this is to prevent spurious annotation of very low level expressed probes with high TSI indexes due to a lack of signal in certain tissue hybridizations. Only the top three tissues are listed in the Tissue Selectivity column.

The Drug Regulation Frequency (DRF) calculation provides a higher-level understanding of a gene's frequency of regulation by all DrugMatrix™ treatments profiled in a given tissue (about 345 compounds in liver, 249 compounds in kidney, 209 compounds in heart, 73 compounds in marrow and 120 compounds in hepatocytes; each with an average of 4 dose-time-tissue combinations in biological triplicate). DRF represents the percent of experiments that either up- or down-regulate a gene by a statistically significant amount within a given tissue. It is calculated by counting all dose-time-tissue combinations where the average log₁₀ normalized signal in the treated group is significantly different (p<0.05) from the average log₁₀-normalized signal of the vehicle controls. The Drug Regulation frequency is then the percentage of all dose-time-tissue treatments where the probe is perturbed. For simplicity, the Drug Regulation Frequency ranking is binned into three categories: H (high), M (medium) and L (low). If the percent perturbation falls within the highest 10 percentile compared to all the probes on the array, it is annotated as H (high); if it falls within the lowest 10 percentile, it is annotated as L (low). Probes in the range between the highest and lowest 10 percentiles are annotated as having M (medium) Drug Regulation Frequency. DRF is calculated independently across nine tissues, including: bone marrow, brain, heart, intestine, kidney, liver, spleen, primary rat hepatocytes, and thigh muscle. Another analysis generated by the chemogenomic report includes tables of the most consistently up and down regulated genes. FIG. 6 shows a panel of the most consistently unregulated genes for this experimental dataset. Significance: For the purpose of this analysis, significance (column labeled T-test min p) is defined as the minimum p-value of the log₁₀ ratio of a given gene across all query treatments. Each of the 5 gene pathway tables is sorted by significance. Reported here is the minus log₁₀ (p-value) rather than the p-value itself. Additional contextual information: Additional contextual information is provided in the last three columns of the table, including: Tissue Intensity and Selectivity, Tissue Selectivity and Drug Regulation Frequency.

### Example 3

### Analysis of Chemogenomic Data Using the DrugMatrix™ Database and the ToxFX Analysis Suite

This example illustrates carrying out analysis of a user's in vivo chemogenomic data on a remote DrugMatrix™ database using the ToxFX Analysis Suite.

### I. Overview of ToxFX

A typical ToxFX study is composed of data generated on multiple arrays and representing multiple time points and compound doses. The ToxFX Analysis Suite makes it possible to submit the data and in minutes get back an analysis report that provides a clear picture of potential safety problems, the genes that are likely to be most important in relation to those problems, and the biological pathways that are most likely to play a role in any predicted toxicity. These results enable decision-making far sooner than the weeks or months that it takes to produce a typical pathology report. The ToxFX analysis accomplishes this task by using several tools including the Iconix DrugMatrix™ reference database (described above in Example 1) and it associated features: Drug Signatures and Pathway Impact analysis.

Analyzing a ToxFX study does not require any prior subscriptions or licensing of either the software or the DrugMatrix™ reference database. Instead, an “Analysis Certificate,” purchased with the array or separately from the database vendor's web-site (e.g., www.ToxFX.com), provides the user with the flexibility and convenience of when and how they perform their ToxFX study. Each Analysis Certificate entitles the user to analyze data from a single array using the reference database. The number of analysis Certificates available to the researcher is conveniently tracked within the ToxFX Study Builder software and debited from the users account when a study is submitted.

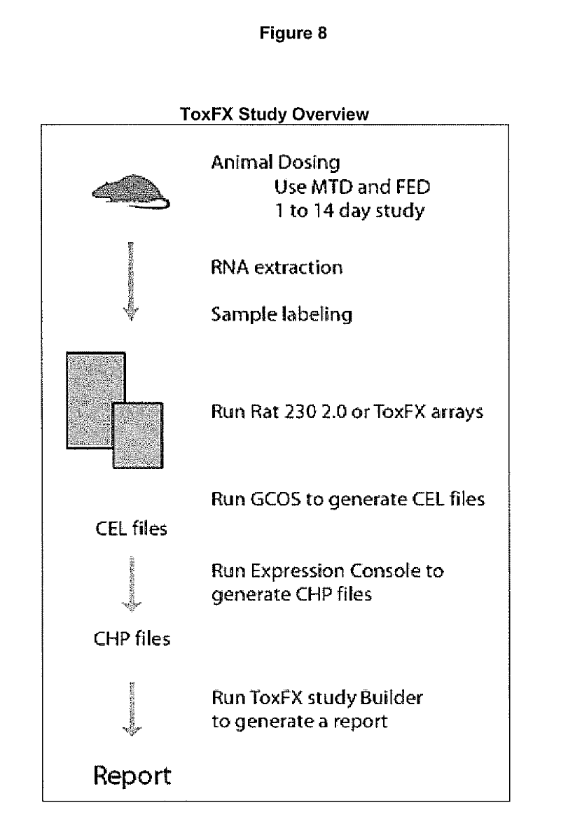

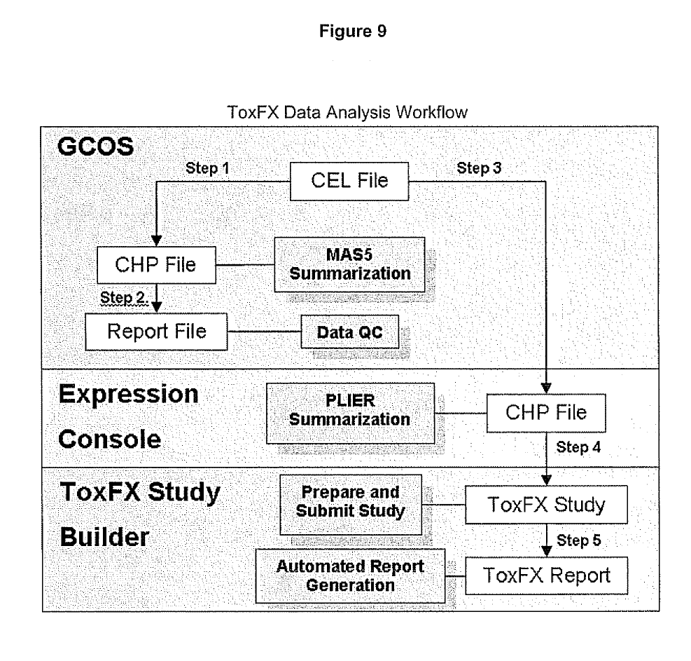

FIG. 8 depicts an overview of a typical study carried out using the ToxFX Analysis Suite. An analysis using ToxFX begins with a typical dose and time response study in the rat as described above in Example 1. Tissue samples are collected and total RNA is extracted and labeled using standard procedures. The labeled cRNA is then run on an Affymetrix GeneChip® microarray. As described further below, ToxFX is designed for use with data obtained using an Affymetrix Rat Genome 230 2.0 or GeneChip® Rat ToxFX 1.0 Array. Following data collection, raw data in the form of CEL files from the Affymetrix GeneChip® microarray is processed in Expression Console™ software and then transferred to the ToxFX Study Builder for final analysis. The ToxFX Study Builder is the software package that provides the web-based user-interface allowing a user to access and control a chemogenomic data analysis using the DrugMatrix™ database located on a remote server. ToxFX provides analysis results summarized in an easy-to-read and comprehensive ToxFX Report delivered as a PDF file directly to the user's computer. FIG. 9 provides a more detailed depiction of the above-described ToxFX data analysis workflow.

### II. Arrays Used with ToxFX Analysis Suite

The ToxFX Analysis Suite is designed to support the analysis of in vivo studies performed exclusively in a rat model system for liver, heart or kidney tissues using either the whole genome GeneChip® Rat Genome 230 2.0 Array or the GeneChip® Rat ToxFX 1.0 Array. The user's choice of array will depend upon the requirements of the study.

The GeneChip® Rat ToxFX 1.0 array includes probe content focused exclusively on those probe sets that the DrugMatrix™ reference database indicates are most informative from a toxicology perspective. For compound screening purposes, the more focused array provides an economical solution for running large numbers of samples.

The GeneChip® Rat Genome 230 2.0 array includes the same probe content as the ToxFX 1.0 Array plus additional genome-wide content coverage. This additional content can provide users with additional information which can be used for a more in-depth study of mechanism-of-toxicity. For example, this additional information can be analyzed if desired through additional DrugMatrix™ consulting services provided by the database vendor.

The probe sets on the GeneChip® Rat ToxFX 1.0 array are based on the knowledge gained from the thousands of experiments in DrugMatrix™ and the associated Drug Signatures and pathway library. The probe sets represent a subset 2073 probe sets from the well proven content found on the Affymetrix GeneChip® Rat Genome 230 2.0 array. This includes 1141 probe sets representing the genes that make up a total of 55 toxicological and pharmacological Drug Signatures in rat heart, liver and kidney. Also included 626 probe sets representing the genes involved in 22 key toxicology pathways, as well as 205 probe sets representing genes that toxicologists widely agree are vital to the understanding of toxic response mechanisms. Table 2 below provides a comparison of the features of the two arrays.

TABLE 2
Comparison of Array Features

| | Rat ToxFX 1.0 | Rat 230 2.0 |
|---|---|---|
| Number of probe sets | 2,073 | 31,042 |
| Feature size | 11 μm | 11 μm |
| Oligo probe length | 25mer | 25mer |
| Probe pairs/sequence | 11 | 11 |
| Control sequences | | |
| included: | | |
| Hybridization | BioB, BioC, | BioB, BioC, |
| controls | BioD& Cre | BioD& Cre |
| Poly-A controls | Dap, Lys, Phe, Thr | Dap, Lys, Phe, Thr |
| Normalization | N/A | 100 probe sets |
| controls | GAPDH, beta-Actin, | GAPDH, beta-Actin, |
| Housekeeping | Hexokinase 1 | Hexokinase 1 |
| controls | 1:100,000* | 1:100,000* |
| Detection sensitivity | | |

Each Rat ToxFX 1.0 Array is purchased with an Analysis Certificate (described below) that entitles the data generated on the array to be submitted for analysis on two separate occasions. For users of the Rat Genome 230 2.0 Array, Analysis Certificates must be purchased separately directly from the DrugMatrix™ database vendor (e.g., Iconix Biosciences). Each analysis certificate allows an array to be submitted twice for analysis.

Detailed information regarding procedures for cRNA target labeling and sample preparation (e.g., cRNA fragmentation), GeneChip® hybridization, washing, GeneChip® fluidics station setup, GeneChip® array scanning, and GeneChip® raw array data analysis are provided in the “GeneChip® Expression Analysis Technical Manual” available as part number 900223 or 900365 (CD-ROM version) from Affymetrix, Inc. (Santa Clara, Calif.).

### III. ToxFX Data Analysis

A. Overview

The ToxFX data analysis of GeneChip® microarray data is a two step process. The first step uses the Affymetrix Expression Console™ Software to create summarized expression values (CHP files) for 3′ expression array feature intensity (CEL) files. The probe set Signal values represent relative gene level expression estimates. The second step uses the ToxFX Study Builder software to submit CHP files to the ToxFX analysis server, which generates the report.

B. GeneChip® Array Quality Control

It is recommended that all CHP files considered for submission meet the Affymetrix recommended quality parameters. For detailed discussion of QC best-practices, please refer the Affymetrix® Data Analysis Fundamentals guide (P/N 701190).

C. CHP File Generation Using Expression Console

The Affymetrix Expression Console software takes CEL files produced in GeneChip® Operating Software (GCOS) as inputs and creates CHP files as outputs. CEL files contain one intensity value per probe feature, while CHP files contain signal values that are summarizations of multiple features that measure the same transcript or pool of transcripts.

A detailed description on the Expression Console software, how to download the current version, and how to use it for data analysis (e.g., create CHP files), can be obtained from Affymetrix at the following URL: www.affymetrix.com/products/software/specific/expression_console_software.affx.

It is preferred that all CHP files that submitted together in the Study Builder also are analyzed together in Expression Console. Simultaneous analysis ensures that a consistent probe affinity model and appropriate normalization are applied across the entire study.

D. ToxFX Study Builder Software

1. General Software Features

The ToxFX Study Builder is a web based user interface software package used for defining a ToxFX study, submitting the gene expression data for analysis to the Iconix ToxFX server, and generating a ToxFX report. The primary goal of the user interface is to capture all of the user's experimental parameters that are needed to configure the analysis and generate the report. All the experimental parameters captured during submission are displayed in the report to provide a detailed record of the study design.

The ToxFX Study Builder software has five major functionalities indicated by visual tabs on the user's display:
1. “Study Panel”—A study is composed of one or more experiments performed with a single compound on a single tissue. The “Study Panel” tab is intended to capture experimental parameters concerning the study design.
2. “Experiments”—An experiment is defined as a single compound dose at a single exposure time. Thus, a study will typically be composed of multiple experiments each representing a single dose and time point. The “Experiments” tab allows an experiment to be created for each dose/time combination and the appropriate treatment and control CHP files to be associated with that experiment.
3. “Compound Chooser”—The available compounds are found in the chemogenomic database (e.g., DrugMatrix) located on the host server and provide additional context to the analysis. The “Compound Chooser” tab allows the user to select the reference compounds for the study. Typically, the software will allow up to three reference compounds can be selected.
4. “Quality Control”—To maximize the probability of obtaining meaningful results through the ToxFX analysis, a data QC check must be performed prior to submitting a study for analysis. Outlier data files are highlighted in red. These files will be excluded from the data analysis. The “Quality Control” tab allows the user to control and monitor the data QC check process.
5. “Certificates”—Each CHP file submitted as part of a study must be accompanied by a valid “Analysis Certificate” provided by the user. For example, a study composed of 24 arrays will require 24 certificates of analysis for submission. Additional analysis certificates can be purchased directly from the Iconix Biosciences web site: www.toxfx.com. The “Certificates” allows the user to control the submission of analysis certificates.

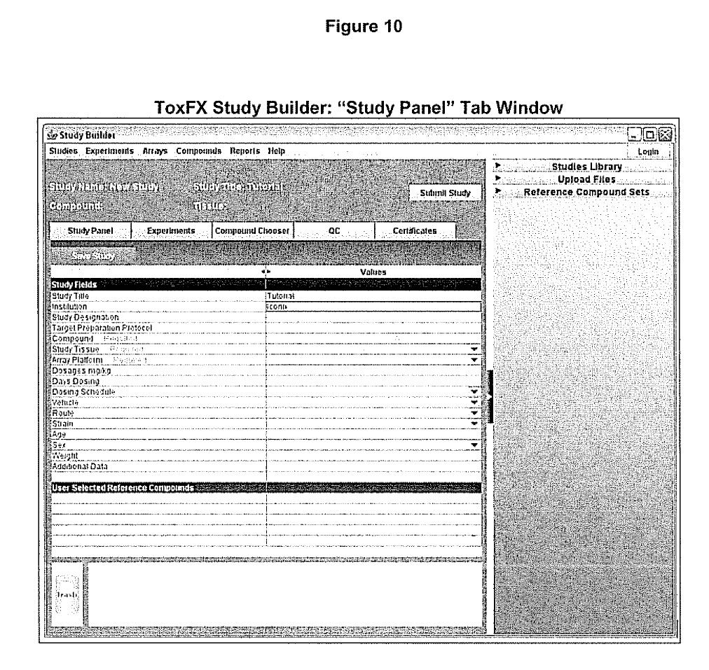

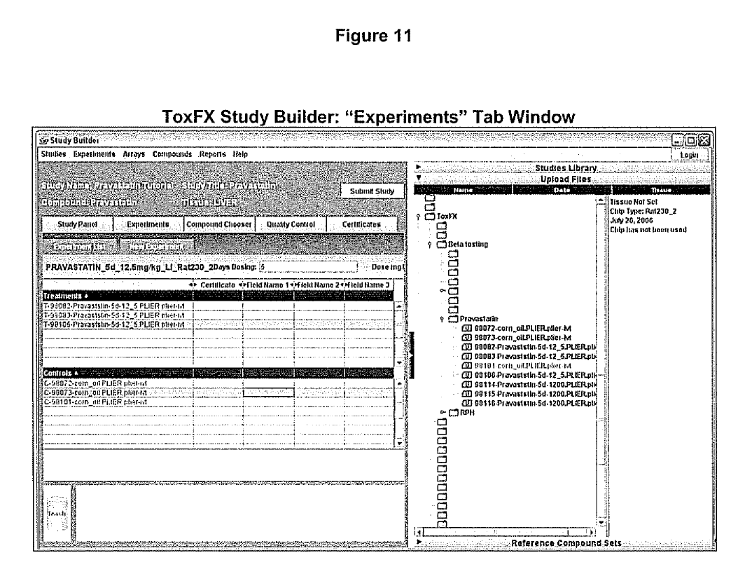

All the above described sections should be filled in before submitting a study for analysis. The software organizes these functionalities visually as a series of tabs proceeding from left to right across the display, as shown in the screenshots of FIGS. 10-14. This left to right arrangement provides an intuitive guide that facilitates the user filling in the study design information. It is intended that the user proceed through the tabs from left to right. Once all of the tab sections necessary to define the study have been completed and the study data has passed QC, submit the data to the server by clicking the Submit Study button. The Study Builder software allows a study can be saved at any time by clicking the Save Study button. Saved studies and other relevant files can be found in the Data File Tree.

2. Software Installation and Removal

The software is deployed to the user's local computer via Java Web Start as included in J2SE 5.0. The software requires internet access to the database host server (e.g., www.toxfx.com) with the appropriate security settings to allowing running the Java Web Start application and download the software. Other local computer requirements include:
Administration access to install software Windows 2000 Service Pack 4 or higher;
Windows XP Service Pack 2 or higher;
Microsoft Internet Explorer 6.0 Service Pack 1 or higher;
Adobe Acrobat 6.0 or higher;
At least 20 MB of disk space.

To Install the ToxFX Study Builder Software the user performs the following steps:
1. Go to the host server web-site (e.g., www.toxfx.com) using the web browser.
2. Click the Download & Launch ToxFX Study Builder link.
3. Administrative privileges on the user's computer are required for initial software installation.
4. A window appears indicating that the application is downloading.
5. The first time you use the application, it will take a few minutes to install.
6. The software is deployed via Java Web Start as included in J2SE 5.0.
7. As part of deployment of the software, a ToxFX Study Builder shortcut icon is added to the user's computer desktop.

To Uninstall the ToxFX Study Builder Software:
1. Copy or move the folder C:\Documents and Settings\user\name\ToxFX\packages to another location. This folder contains the results, including reports and data archives, from all previous ToxFX Study Builder submissions.
2. Delete the folder C:\Documents and Settings\username\ToxFX.
3. Delete the icon on the desktop if it had been installed.

3. Starting and Logging Into Study Builder Software

To Start and Log in to the ToxFX Study Builder Software:
1. Once the application has been installed, start the ToxFX Study Builder application by clicking the ToxFX Study Builder shortcut icon located on the desktop.
2. Login by clicking the Login button located in the upper right portion of the Study Builder window.
3. Enter User Name and Password information.
4. For new users, go to www.toxfx.com to register for a ToxFX account.
5. Click Login. The Study Builder window appears as shown in FIG. 10.

4. Using the “Study Panel” Tab

A study comprises all the arrays, annotations and reference data associated with a single compound in vivo study. The Study Panel is the page where all the experimental information surrounding the study design is captured. The following steps illustrate the use of the Study Panel tab:
1. Enter information in the fields either by typing in the text or using the provided dropdown menus. Some fields that provide drop-down choices can be overwritten by typing the desired information directly into the field.
2. Information entered in the red fields is required to determine which signatures and pathways will appear in the Report. The remainder of the fields is not used for any calculations but are an aid for record keeping.
3. The entries will appear in the Study Summary and the Executive Summary in the Report.

Only the fields in red are required to be filled in. All other fields are optional. Accurate record keeping of all the experimental conditions adds significantly to the value of a study. Preferably, the user fills in the fields as completely as possible.

A study can be saved at any stage by clicking the “Save Study” button provided on the display. The software permits the user to drag a specific previously saved study icon from the “Studies Library” bar and drop it into the Study Panel to populate the fields. A study also can be deleted by dragging it into the Trash icon. A progress box at the bottom of the window shows the program status and messages.

5. Using the “Experiments” Tab

A study consists of a number of experiments, where each experiment represents a single time and dose. Each experiment must contain a minimum of two control and treatment replicates; if this replicate minimum requirement is not met, the study will be rejected. However, inclusion of three or more control and treatment replicates in a study is highly recommended. Using the “Experiments” tab, up to 15 experiments can be created for different time points and doses of the same compound. The following user steps illustrate the use of the “Experiments” tab in the Study Builder software:
1. Click the New Experiment button. A new window opens.
2. Fill in the Dose and the Time for the experiment and click Save.
3. To Load the CHP files, click the triangle on the left in the Upload Files bar (top right of the display window) in the Data File Tree. Only CHP files will be displayed in this panel of the Data File Tree. The Study Builder software is designed so that it only accepts CHP files produced by the Expression Console. To convert CEL files to CHP files, the user follows the Expression Console instructions (as described above). The file browser opens.
4. Browse to the location of the files. When a folder (directory) is opened for the first time in a session, the program reads the header information of all the CHP files. If a folder contains a large number of CHP files it may take a few minutes for the folder to open.
5. Once located, the desired CHP files can be dragged and dropped into the experiment table. Care must be taken to ensure that the control and treatment files are dropped into the Controls and Treatments sub-panels of the Experiments panel respectively. To prevent errors in dragging and dropping, the color of the window will momentarily change to green if the action is allowed. If the window turns red, the operation is not allowed and an explanation will appear in the Status Box at the bottom of the window.
6. If necessary, files can be removed from either the Treatments or Controls sub-panels by selecting the file and dragging it to the Trash located in the lower left corner of the window.
7. Also, if necessary, the different experiments that exist within the study can be reviewed by clicking the Experiments List button.

Generally, the user should not rename CHP files. Renamed CHP files will not appear in the browser. To rename CHP files, user should rename the CEL files and re-run the analysis for all files in the study in the Expression Console software.

6 Using the “Compound Chooser Tab

The Compound Chooser panel allows the user to search for specific compounds that can be used as a reference for comparison to the test compound using a variety of filters. The user is able to select up to 3 compounds from the reference database of 458 compounds. The user can select the compounds based upon their classification. The classification classes are based upon classical toxicological observations such as histopathology or clinical chemistry. The following classifications are available: Activity Class; Blood Chemistry and Hematology; Histopathology; Literature Annotation; Molecular Pharmacology; Organ Weight; and Structure Activity Class. Alternatively, a text search can be used. Since compound effects are tissue specific, the list of reference compounds available for inclusion in a study depends on the tissue selected in the drop-down box in the upper left hand corner of the “Compound Chooser” tab display.

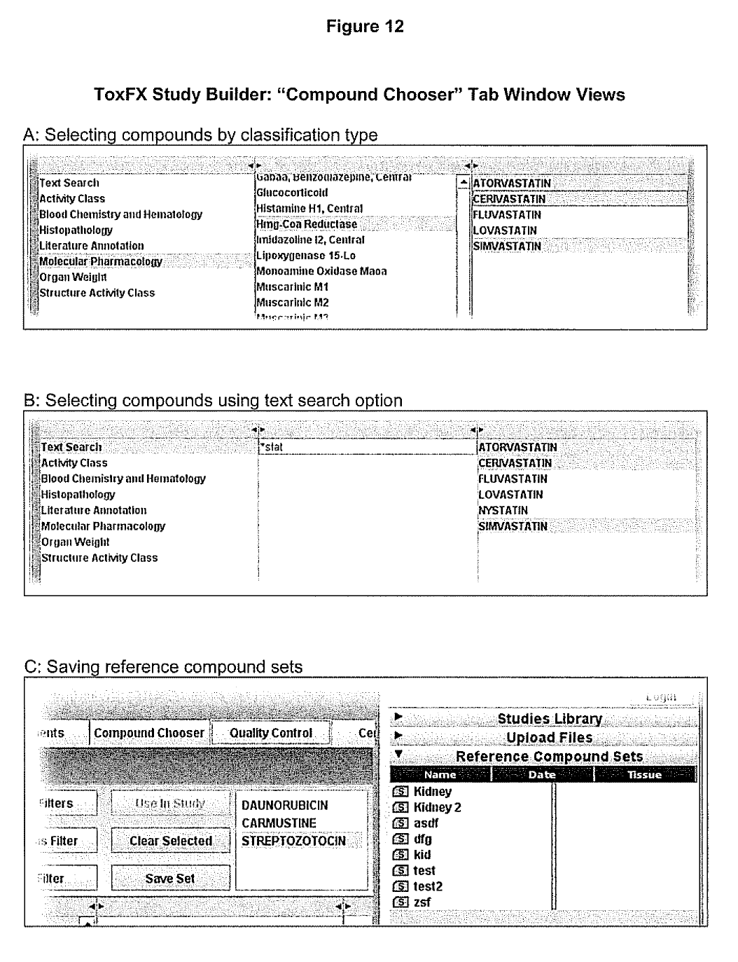

The following user steps illustrate selecting compounds by classification type using the “Compound Chooser” tab in the Study Builder software (see FIG. 12A for illustrative software screenshot):
1. Select the appropriate tissue choice from the tissue drop down menu located at the upper right of the Compound Chooser panel. The default tissue selection is liver.
2. Select the classification type of interest in the left-most column.
3. Select the sub-classification type of interest displayed in the center column.

The list of compounds associated with that classification appears in the right-most column.
4. Drag and drop the desired reference compound name of interest into the box directly above the right-most column of the Compound Chooser. Up to 3 reference compounds are allowed.
5. To remove unwanted compounds, select the compound and click the Clear Selected button.
6. When the final compound selection is complete, click the Use In Study button. Selected compounds will be displayed at the bottom of the Study Panel tab.

To find compounds matching two or more classification categories, the filter functionality can be used. The following user steps illustrate using the filters in the “Compound Chooser” tab to select reference compounds of interest that are found in the intersection of two different classes or sub-classes:
1. Select the first classification type of interest in the left-most column.
2. If a subclass is of interest, select that from the middle column.
3. Click the Add Filter button found directly above the Compound Chooser.
4. In an identical manner as described in Steps 1 and 2, use the Compound Chooser to find the second classification type of interest. Only compounds that meet the criteria of both the first category and the second category will now be displayed in the right-most column. The parameters of the current filter are displayed in the Status Box at the bottom of the window.
5. The filter can be removed by clicking Reset Filter.
6. A previously used filter can be used by clicking Previous Filter.

The following user steps illustrate selecting compounds by text search using the “Compound Chooser” tab in the Study Builder software (see FIG. 12B for illustrative software screenshot):
1. Select the appropriate tissue choice from the tissue drop down menu located at the upper right of the Compound Chooser panel. The default selection is liver.
2. Select the Text Search option at the top of the left-most column.
3. Type the search string of interest into the text search box that appears in the middle column. Wild-card characters are supported. For example, to find the complete list of statin family members, “*stat” could be entered in the text search window.
4. The results are dynamically filtered as the text is typed in. Drag and drop the compound name of choice from the lower right-most column into the box directly above it.
5. To use one of the compounds as a reference, drag and drop the compound name of interest into the box directly above the right-most column of the Compound Chooser.
6. To remove unwanted compounds, select the compound and click the Clear Selected button.
7. When the final compound selection is complete, click the Use In Study button. Up to 3 reference compounds will be allowed. Selected compounds will be displayed at the bottom of the Study Panel tab.

Once a set of reference compounds has been selected, the set can be saved for future use. The following user steps illustrate saving selected reference compounds using the “Compound Chooser” tab in the Study Builder software (see FIG. 12C for illustrative software screenshot):
1. Click the Save Set button. A pop-up window will appear requesting a name for the Compound Set.
2. Enter a name and click Save. The Compound Set appears in the browse window on the right.
3. Compound Sets that are no longer needed can be dragged and dropped into the trash bin at the bottom left of the page.

7. Using the “Quality Control” Tab

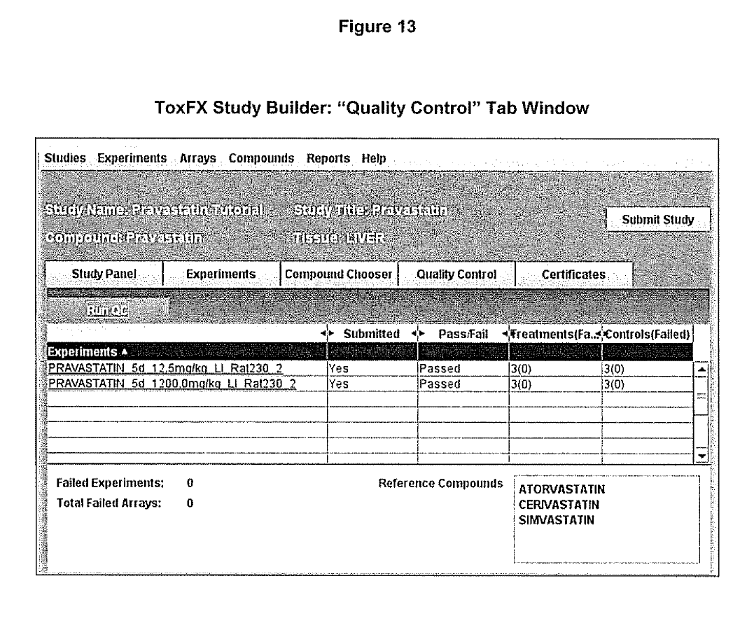

Before any data is submitted for ToxFX analysis, a quality control (QC) step is required. This step focuses only on the reproducibility of the biological replicates and is in addition to the recommended GeneChip® quality control parameters. During the QC step, the concordance between experimental replicates is assessed using a Pearson's correlation test. A CHP file whose correlation to other experimental replicates falls below a threshold of r2=0.8 is considered to be an outlier. The following user steps illustrate performing data QC analysis using the “Quality Control” tab in the Study Builder software (see FIG. 13 for illustrative software screenshot):
1. Click the Quality Control tab.
2. Confirm that the study organization is correct. If a CHP file has been mislabeled as a control or treatment, return to the Experiment tab to correct the problem.
3. Click the Run QC button.
4. Failed treatments and controls will be highlighted with a red background behind the experiment row.

If an individual array fails during the QC step, it will automatically be omitted from the analysis when the study is submitted to the database host site. The failed array does not need to be removed from the study before submission. However, there must be two or more arrays in the experiment that exceed QC specifications for the user to proceed with submission. If a study fails during the QC step, it cannot be submitted for analysis to the database. The user should review the study design and array QC data to establish a reason for experiment failure. Typical reasons for experiment failure may be a mix-up between control and treatment arrays or may be due to uncontrolled experimental or process variability.

8. Using the “Certificates” Tab

The Certificates tab will display the number of certificates required for submission of the currently defined study. It also provides a record of the number of available certificates in the users account. A study can only be submitted if the complete number of certificates are available for the entire study. The following user steps illustrate using the “Certificates” tab in the Study Builder software:
1. Click the Certificates tab.
2. Click the Check button found in the upper left corner to verify the number of certificates available.
3. The required number of certificates for the currently defined study and the number of available certificates is displayed at the bottom of the Certificates panel.
4. Additional certificates may be purchased if there are not enough available.

Study Submission
1. Verify that all the entered data is correct.
2. Click the Submit Study button. If not already logged into the ToxFX server, the user will be prompted to do so at this time.
3. Enter the Username and Password information.
4. Click Login. The study is now submitted to the server hosting the DrugMatrix™ database for analysis and report generation.

9. Data Output

The ToxFX Analysis Suite presents data in a consistent manner so that data generated from different compounds and/or from different studies can be directly compared. For example, one or more compounds from a series may be prioritized for advancement during lead optimization based on the comparison of their safety profiles in addition to their pharmacological properties.

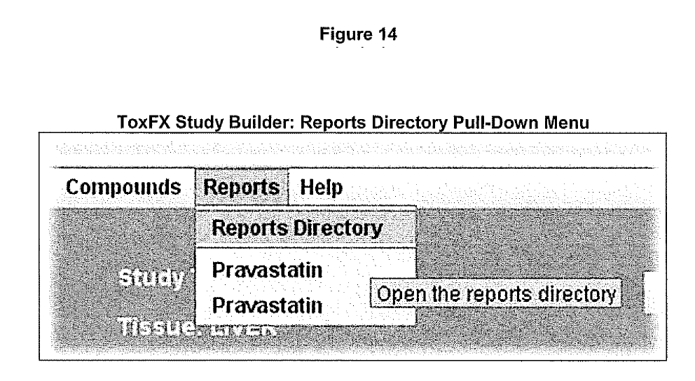

Typically, within several minutes of successfully submitting a study (and the necessary certificates) using the Study Builder software, the ToxFX Report (described below) is generated and displayed on the user's local computer using Adobe Acrobat Viewer. The report is saved on the local computer in the file path C:\Documents and Settings\username\ToxFX\packages. The reports folder can be accessed by going to the Reports pull-down menu and selecting Reports Directory as shown in FIG. 14.

The ToxFX data is returned to the user in two forms: (1) a ToxFX Report, which is a final comprehensive report that is ready to be shared with members of the project team; and (2) a ToxFX Data Archive, which includes all data underlying the tables and figures of the ToxFX Report in a compressed archives
The compressed ToxFX Data Archive includes the following contents:
ToxFX Report: A second copy of the report is included in the data archive providing a complete file archive that can be easily shared with colleagues or archived to a network location.
High-resolution images: High resolution images of the graphs in the ToxFX Report are provided as SVG files. SVG files are vector graphic files that can be edited with image editor programs such as Adobe Illustrator. This allows the user to add comments or combine figures for custom in-house reports or publications. Vector graphic files produce very high resolution printing for posters and publications. The following graphs in the report are provided as SVG files and contain the similarly named figures from the report respectively: “compoundimpact.svg”; and “perturbation.svg”.
Data files—Data files can be used for additional data analysis. The following data files are generated: “Geneperturbations.tab”; “Pathwayresponses.tab”; “Signatureresponses.tab.”

### IV. ToxFX Report Structure and Content

A. Overview of Report Content

The ToxFX Report is an Adobe Acrobat PDF document divided into the following discrete sections:

1. Executive Summary

The executive summary is an abstract summarizing the most important findings of the study. It is restricted to a single page allowing the reader to very quickly formulate an understanding of the main findings of the study.

2. Table of Contents

All sections of the report are indexed with page numbers.

3. Study Description and Study Summary

The Study Description and Study Summary pages present an overview of the experimental parameters provided by the user. This information provides a record of how the study was conducted and simplifies the comparison of different Reports.

4. Relative impact on Transcription

Achieving an appropriate dose capable of eliciting a robust gene expression response is critical to the success of a toxicogenomic study. By comparing the number of observed gene expression perturbations to the distribution of gene expression perturbations measured for all drugs represented in the DrugMatrix™ reference database, the user very quickly gains an understanding of the validity of the chosen dosing regimen.

Ideally the test compound at the maximum tolerated dose (MTD) should perturb the expression levels of greater than 25% of genes so that a robust interpretation can be made. If very fewer gene expression changes are observed, the compound is most likely under-dosed. In this situation we would recommend a review of the dose selection data to verify that the compound achieved MTD levels. If the user data shows that MTD was achieved, and the number of gene expression changes is small, then compound safety may already be indicated and very few transcriptional signs of pathological/toxicological events should be observed.

Drug Signature biomarkers provide rapid predictions of key toxicological endpoints usually measured by a variety of classical toxicology assays such as histopathology and blood chemistry.

The degree to which the gene expression profile of a given drug-dose-time treatment matches a Drug Signature is reported using the posterior probability score (PPS). The PPS is derived from the distribution patterns in the positive and negative training sets. If the value of the PPS for the compound under study is near 1, there is high confidence that the compound treatment matches the expression pattern of the phenotype described by the signature. Conversely, if the probability is near 0, a match is very unlikely. Values near 0.5 indicate that there is an equal probability that the treatment does or does not match the expression pattern of the reference treatments. Two thresholds are recommended when interpreting the Drug Signature output. Values of 0.75 and above are considered likely matches because the pattern is three-fold more likely to match the pattern than not match the pattern. Likewise, values of 0.9 indicate that it is 9-times more likely to match the pattern, and thus would be considered a very strong match.

The ToxFX Analysis Suite analyzes the user dataset with respect to at least 55 different Drug Signatures. Consequently, the ToxFX Report includes results for at least the following 55 well-characterized Drug Signatures from the Drug Matrix database shown below in Table 3. As denoted in Table 3, certain signatures are analyzed only with respect to certain tissue samples.

TABLE 3
ToxFX Drug Signatures

| Signature | Liver | Kidney | Heart |
|---|---|---|---|
| Adrenergic agonist | | | ✓ |
| Bile Duct Hyperplasia | ✓ | | |
| Cholesterol biosynthesis inhibitor | ✓ | ✓ | |
| Cardiac cellular infiltration | | | ✓ |
| Cardiac myocyte degeneration | | | ✓ |
| DNA damager | | ✓ | |
| DNA intercalator, anthracycline-like | | ✓ | |
| Erythrocyte count increase | | ✓ | |
| Estrogen receptor agonist | ✓ | | |
| Estrogen receptor alpha binding | | ✓ | |
| Glucocorticoid and mineralocorticoid | ✓ | ✓ | ✓ |
| receptor agonist | | | |
| Heart weight increase | | | ✓ |
| Hepatic eosinophilia, centrilobular | ✓ | | |
| Hepatic eosinophilia, early gene expression | ✓ | | |
| Hepatic fibrosis | ✓ | | |
| Hepatic hypertrophy, centrilobular | ✓ | | |
| Hepatic inflammatory infiltrate, | ✓ | | |
| centrilobular | | | |
| Hepatic inflammatory infiltrate, early | ✓ | | |
| gene expression | | | |
| Hepatic lipid accumulation, centrilobular | ✓ | | |
| Hepatic lipid accumulation, macrovesicular | ✓ | | |
| Hepatic lipid accumulation, | ✓ | | |
| microvesicular, centrilobular | | | |
| Hepatic lipid accumulation,, periportal | ✓ | | |
| Hepatic necrosis | ✓ | | |
| Hepatoceliular hypertrophy, diffuse | ✓ | | |
| Hepatomegaly | ✓ | | |
| Hypoalbuminemia | ✓ | | ✓ |
| Leukocytosis, early gene expression | ✓ | | |
| Leukopenia | ✓ | | |
| Lymphocytosis | ✓ | | |
| Lymphopenia | ✓ | | ✓ |
| Nephromegaly | | ✓ | |
| Neutrophilia | ✓ | | ✓ |
| Non-DNA reactive antiproliferative agent | | | ✓ |
| Peroxisome proliferator | ✓ | ✓ | ✓ |
| Pregnane X receptor activation | ✓ | | |
| Renal tubular necrosis | | ✓ | |
| Renal tubular nephrosis | | ✓ | |
| Renal tubular proteinaceous cast | | ✓ | |
| Renal tubular regeneration | | ✓ | |
| Renin-angiotensin-aldosterone inhibitor | | ✓ | |
| Serum alanine aminotransferase increase | ✓ | | |
| Serum bilirubin and alkaline phosphatase | ✓ | | |
| increase | | | |
| Thyroperoxidase inhibitor | ✓ | | |
| Toxicant, DNA alkylator | ✓ | | ✓ |
| Toxicant, heavy metal-like | | ✓ | |

6. Pathways

Mechanistic information on compound action and off-target effects is available in custom-annotated pathways. There are 22 pathways analyzed in detail as part of the ToxFX analysis. These pathways are specifically designed to help users better understand, at the molecular level, the mechanism of pharmacologic action and toxicity, connecting regulatory and metabolic processes with physiological or toxicological responses. The curation of the provided pathway maps includes information ascertained from both Iconix experimentation as well as in-depth literature review of the subject area. Peer-reviewed articles from Science, Nature, Nature Review Drug Discovery, Nature Medicine, Cell, and Cell Metabolism provide the basis for the background information provided in the text summaries.

To provide important context and perspective to the pathways from a toxicological perspective, the ToxFX Analysis Suite pathway analysis highlights:
Known targets for drug interaction within each pathway drawings.
General background information and provides guidance to key elements.

For easy interpretation, the overall impact of the compound treatment under investigation for all toxicological pathways relevant to the tissue is provided in a single figure. The figure includes a variety of information that together enables the user to quickly elucidate potential mechanisms-of-action and identify pathways of key interest for further follow-up.

Table 4 below summarizes the 22 pathways for which user data analyzed in the ToxFX Analysis Suite.

TABLE 4
Pathways included in ToxFX Report

| Pathways | Liver | Heart | Kidney |
|---|---|---|---|
| Xenobiotic Metabolism | ✓ | ✓ | ✓ |
| Aryl Hydrocarbon Receptor Signaling | ✓ | ✓ | ✓ |
| Apoptosis | ✓ | ✓ | ✓ |
| Hepatic Stellate Cell Activation & Fibrosis | ✓ | | |
| Angiotensin II & Cardiac Hypertrophy | | ✓ | |
| Hepatic Steatosis | ✓ | | |
| Hepatic Cholestasis | ✓ | | |
| Cholesterol Biosynthesis | ✓ | | |
| Beta-Oxidation of Fatty Acid | ✓ | ✓ | ✓ |
| Fatty Acid Biosynthesis & its Regulation | ✓ | ✓ | ✓ |
| Acute Phase Response | ✓ | ✓ | ✓ |
| LPS & IL-1 Mediated Inhibition of RXR | ✓ | | |
| Function | | | |
| NF-kappa B Signaling | ✓ | ✓ | ✓ |
| TGF-beta Signaling | ✓ | ✓ | ✓ |
| Nrf2 Mediated Oxidative Stress Response | ✓ | ✓ | ✓ |
| Hypoxia and HIF Signaling | ✓ | ✓ | ✓ |
| ELF2 Kinase Mediated Stress Response | ✓ | ✓ | ✓ |
| p53 Signaling | ✓ | ✓ | ✓ |
| Cell Cycle G1/S Transition | ✓ | ✓ | ✓ |
| Cell Cycle G2/M Transition | ✓ | ✓ | ✓ |
| Mitochondrial Oxidative Phosphorylation | ✓ | ✓ | ✓ |
| Thyroid Hormone Synthesis, Regulation & | ✓ | ✓ | |
| Release | | | |

The effect of the compound on each pathway is assessed based on two different metrics:

1. Maximum Pathway Impact (using Fisher's exact test). The number of up and down regulated genes in the pathway and the total number of genes in the pathway are displayed in the first three columns. This data is used to compute the Fishers exact statistic. This statistic indicates whether the number of regulated genes is more than the number that would be expected by chance given the p-value for change, p<0.01 in this case.

2. Relative Pathway Response: The magnitude of overall gene expression changes detected in a given pathway is estimated by taking the sum of the absolute fold-change values for all genes in the pathway. To provide context to the measured response, it is compared to all tissue matched drug treatments in the DrugMatrix™ database. A value within the 90th percentile would indicate that the magnitude of the gene changes for any particular pathway induced by the query treatment is greater than 90% of all the drug-dose-time treatments in DrugMatrix. This is considered a significant change. Conversely, a value of less than the 90th percentile would not be considered to be a major event as this is frequently seen in DrugMatrix. The bar chart inset shows the maximum impact among the various dose-time combinations submitted by the user. Greater than two stars in the Fishers exact column (p<0.01) AND an impact factor above the 90th percentile warrants consideration as a significant finding. Other findings may be significant but occur too often to warrant detailed follow-up, unless some other evidence, from this report or through prior-knowledge from the investigator, suggests that the finding is significant. Typically, the maximum impact is more revealing about the probable mechanism of toxicity than the individual impact factors.

7. Cytochrome P450 Families

Given the importance of the P450 genes to toxic response, 62 members of the P450 family are presented in a single table for easy access to this critical information.

8. Most Consistent Gene Expression Changes

A variety of tables providing the most consistently up- and down-regulated genes provide a starting point for additional expert analysis.

9. Supplementary Information

The Pathway Tables and Figures displayed in the Supplementary Information section of the ToxFX Report enable the user to further investigate and understand at the molecular level the pathway response across all genes related to a given pathway (e.g., Fatty Acid Biosynthesis and its Regulation). For each treatment condition defined in the study, the table displays the expression level changes detected for all genes in the pathway and highlights those changes that meet a pre-chosen statistically significance threshold (p<0.01 when comparing the treatment and control groups). To aid in interpreting the impact of the detected gene level changes, additional information describing how frequently these genes are transcriptionally perturbed by the reference compounds contained in the DrugMatrix™ database is provided. This additional data is critical in distinguishing between common, generic changes and rare, specific changes.
Signatures—Detailed background information on each Drug Signature is provided including an estimate of the sensitivity and specificity of the signature, how the signature was derived and what drugs within the database exhibit strong matches to the signature.
Pathways—Detailed information on changes detected in pathways of key toxicological interest is provided. Extensively annotated pathway maps are provided for each pathway to aid data interpretation.
Replicate Reproducibility Check—The results of the concordance QC step are documented for easy review.
Appendix—Details about ToxFX study design, analysis methodologies and data interpretation are provided.

All publications and patent applications cited in this specification are herein incorporated by reference as if each individual publication or patent application were specifically and individually indicated to be incorporated by reference.

Although the foregoing invention has been described in some detail by way of illustration and example for clarity and understanding, it will be readily apparent to one of ordinary skill in the art in light of the teachings of this invention that certain changes and modifications may be made thereto without departing from the spirit and scope of the appended claims.

What is claimed:

1. A method for analysis of client data on a remote chemogenomic database, said method comprising:
a) providing a remote computer connected to a distributed network comprising a client computer, wherein said remote computer comprises a chemogenomic database and analysis software;
b) transmitting executable code from said remote computer to said client computer, wherein said executable code comprises instructions for:
i) accepting input of client data and an access key; and
ii) transmitting said client data and access key to said remote computer;
c) receiving transmission of said client data and access key from said client computer;
d) analyzing said client data using said database;
e) generating a data analysis report on said remote computer; and
f) transmitting the data analysis report from said remote computer to said client computer.

2. The method of claim 1, wherein said method further comprises deleting the client data and the data analysis report from the remote computer after the report is transmitted to the client computer.

3. The method of claim 1, wherein the method further comprises deleting the executable code on the client computer after the access key and client data is transmitted to the remote computer.

4. The method of claim 1, wherein said executable code further comprises instructions for validating the quality of said client data.

5. The method of claim 4, wherein said validating of client data comprises calculating a Pearson's correlation coefficient.

6. The method of claim 1, wherein said executable code further comprises instructions for removing extraneous data from said client data.

7. The method of claim 1, wherein said executable code comprises instructions for generating a graphical user interface capable of accepting client data input on said client computer.

8. The method of claim 1, wherein said method further comprises providing a gene expression assay device in packaged combination with an access key.

9. The method of claim 1, wherein said client data comprises gene expression data from a gene expression assay device.

10. The method of claim 9, wherein the gene expression assay device is a DNA microarray or a PCR reagent kit.

11. The method of claim 1, wherein the access key identifies an individual gene expression assay device.

12. The method of claim 1, wherein the data analysis report comprises results of drug signature probability matching analysis.

13. The method of claim 1, wherein the data analysis report comprises results of pathway response pattern matching analysis.

14. A software product encoded in a computer-readable medium wherein said software product comprises instructions for:
a) transmitting executable code from said remote computer to said client computer, wherein said executable code comprises instructions for:
i) accepting input of client data and an access key; and
ii) transmitting said client data and access key to said remote computer;
b) receiving transmission of said client data and access key from said client computer;
c) analyzing said client data using said database;
d) generating a data analysis report on said remote computer; and
e) transmitting the data analysis report from said remote computer to said client computer.

15. The software product of claim 14, wherein said product further comprises instructions for deleting the client data and the data analysis report from the remote computer after the report is transmitted to the client computer.

16. The software product of claim 14, wherein said product further comprises instructions for deleting the executable code on the client computer after the access key and client data is transmitted to the remote computer.

17. The software product of claim 14, wherein said transmitted executable code further comprises instructions for validating of the quality of said client data.

18. The software product of claim 14, wherein said validating of client chemogenomic data comprises calculating a Pearson's correlation coefficient.

19. The software product of claim 14, wherein said transmitted executable code further comprises instructions for removing extraneous data from said client data.

20. A kit comprising a gene expression assay device in packaged combination with an access key, wherein said access key allows analysis of data from said gene expression assay device on a remote chemogenomic database.

21. The kit of claim 20, wherein the gene expression assay device is a DNA microarray or a PCR reagent kit.
